(19) United States
(12) Patent Application Publication
(10) Pub. No.: US 2024/0054182 A1
(43) Pub. Date: Feb. 15, 2024

(54) Data processing method and device

(71) Applicant: Hangzhou AliCloud Feitian Information Technology Co., Ltd., Hangzhou (CN)

(72) Inventors: GUIMING WU, Hangzhou (CN); JIALI JIANG, Hangzhou (CN); Qianwen He, Hangzhou (CN); Zhenxiang Zhang, Hangzhou (CN); Xin LONG, Hangzhou (CN)

(21) Appl. No.: 18/493,594

(22) Filed: Oct. 24, 2023

Related U.S. Application Data
(63) Continuation of application No. PCT/CN2022/087804, filed on Apr. 20, 2022.

(30) Foreign Application Priority Data
Apr. 25, 2021 (CN) 202110448967.6

(51) Int. Cl. G06F 17/16; G06F 7/72

(52) U.S. Cl. CPC G06F 17/16; G06F 7/722

(57) ABSTRACT

Embodiments of the present disclosure provide a data processing method and apparatus, wherein the data processing method includes: determining a first matrix and a second matrix, and splitting the second matrix into a first preset quantity of matrix blocks; invoking a Montgomery modular multiplication and addition instruction to perform an operation on an element included in the first matrix and an element included in a j^{th} matrix block to obtain a matrix block operation result corresponding to the j^{th} matrix block, and covering the element in the j^{th} matrix block with the matrix block operation result corresponding to the j^{th} matrix block; and increasing j by 1, continuing to perform the above-described step of obtaining the matrix block operation result until j is equal to the first preset quantity so as to obtain a target matrix from the matrix multiplication operation performed on the first matrix and the second matrix. In this way, a high-performance matrix multiplication algorithm based on Montgomery modular multiplication and addition is provided, which reduces operational complexity, effectively uses the advantages of batch processing of the Montgomery modular multiplication and addition instruction, and improves the operation efficiency of a processor performing a matrix multiplication operation.

### CROSS REFERENCE TO RELATED APPLICATION

This application claims priority to and is a continuation of PCT Patent Application No. PCT/CN2022/087804, filed on 20 Apr. 2022 and entitled “DATA PROCESSING METHOD AND APPARATUS,” which claims priority to Chinese Patent Application No. 202110448967.6, filed on 25 Apr. 2021 and entitled “DATA PROCESSING METHOD AND APPARATUS,” which are incorporated herein by reference in their entirety.

### TECHNICAL FIELD

The present disclosure relate to the field of computer technology, and, more particularly, to data processing methods. One or more embodiments of the present disclosure further relate to data processing apparatuses, computing devices, and computer-readable storage media.

### BACKGROUND

With the rapid development of computer technology, the Poseidon Hash algorithm is more widely applied to the fields of blockchains and privacy protection as the latest hash function, thereby improving data security. The core operation in the Poseidon Hash algorithm is the modular multiplication operation of a matrix (matrix multiplication for short). The modular multiplication operation refers to an operation of multiplying a matrix first and then taking the remainder. That is, when the modular multiplication operation is performed, the matrix is subjected to a multiplication operation first and then subjected to a division operation. Such operation process is complicated, which causes low efficiency of the modular multiplication operation of the matrix. Therefore, how to improve the efficiency of performing a modular multiplication operation on a matrix and save processing time is a main problem currently. Therefore, a data processing method with higher efficiency needs to be provided when performing a modular multiplication operation on a matrix.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The embodiments of the present disclosure provide data processing methods. One or more embodiments of the present disclosure further relate to data processing apparatuses, computing devices, and computer-readable storage media, so as to solve the technical defects existing in the conventional techniques.

According to an example embodiment of the present disclosure, a data processing method is provided, comprising:
S1: determining a first matrix and a second matrix, and splitting the second matrix into a first preset quantity of matrix blocks;
S2: invoking a Montgomery modular multiplication and addition instruction to perform an operation on an element comprised in the first matrix and an element comprised in a j^{th} matrix block to obtain a matrix block operation result corresponding to the j^{th} matrix block. For example, j starts from 1. The Montgomery modular multiplication and addition instruction is used to simultaneously implement multiplication and addition operations of a Montgomery domain;
S3: covering the element in the j^{th} matrix block with the matrix block operation result corresponding to the j^{th} matrix block; and
S4: increasing j by 1, continuing to perform the step S2 until j is equal to the first preset quantity, and obtaining a target matrix from the matrix multiplication operation performed on the first matrix and the second matrix.

According to an example embodiment of the present disclosure, a data processing apparatus is provided, comprising:
a splitting module, configured to determine a first matrix and a second matrix, and split the second matrix into a first preset quantity of matrix blocks;
an invoking module, configured to invoke a Montgomery modular multiplication and addition instruction to perform an operation on an element comprised in the first matrix and an element comprised in a j^{th} matrix block to obtain a matrix block operation result corresponding to the j^{th} matrix block. For example, j starts from 1. The Montgomery modular multiplication and addition instruction is used to simultaneously implement multiplication and addition operations of a Montgomery domain;
a covering module, configured to cover the element in the j^{th} matrix block with the matrix block operation result corresponding to the j^{th} matrix block; and
an execution module, configured to increase j by 1, continue to execute the invoking module until j is equal to the first preset quantity, and obtain a target matrix from the matrix multiplication operation performed on the first matrix and the second matrix.

According to an example embodiment of the present disclosure, a computing device is provided, comprising:
a memory and a processor;
wherein the memory is configured to store computer-executable instructions, and the processor is configured to execute the computer-executable instructions to implement the following steps:
S1: determine a first matrix and a second matrix, and split the second matrix into a first preset quantity of matrix blocks;
S2: invoke a Montgomery modular multiplication and addition instruction to perform an operation on an element comprised in the first matrix and an element comprised in a j^{th} matrix block to obtain a matrix block operation result corresponding to the j^{th} matrix block. For example, j starts from 1. The Montgomery modular multiplication and addition instruction is used to simultaneously implement multiplication and addition operations of a Montgomery domain;
S3: cover the element in the j^{th} matrix block with the matrix block operation result corresponding to the j^{th} matrix block; and
S4: increase j by 1, continue to perform the step S2 until j is equal to the first preset quantity, and obtain a target matrix from the matrix multiplication operation performed on the first matrix and the second matrix.

According to an example embodiment of the present disclosure, a computer-readable storage medium having computer-executable instructions stored thereon is provided, and when the instructions are executed by a processor, the steps of the data processing method according to any one of the implementations are implemented.

An embodiment of the present disclosure provides a data processing method, which comprises: determining a first matrix and a second matrix, and splitting the second matrix into a first preset quantity of matrix blocks; invoking a Montgomery modular multiplication and addition instruction to perform an operation on an element included in the first matrix and an element included in a j^{th} matrix block to obtain a matrix block operation result corresponding to the j^{th} matrix block, and covering the element in the j^{th} matrix block with the matrix block operation result corresponding to the j^{th} matrix block; and increasing j by 1, continuing to perform the above-described step of obtaining the matrix block operation result until j is equal to the first preset quantity, and obtaining a target matrix from the matrix multiplication operation performed on the first matrix and the second matrix. In this way, a high-performance matrix modular multiplication algorithm based on Montgomery modular multiplication and addition is provided, wherein the second matrix is split into a plurality of matrix blocks, and then a result of the operation with the first matrix is used to cover an original element in the matrix block to obtain a target matrix after the matrix multiplication operation, which simplifies an operation process of the matrix multiplication operation and reduces operation complexity. In addition, a complex operation between an element included in the first matrix and an element included in a j^{th} matrix block can be implemented by invoking a Montgomery modular multiplication and addition instruction, so as to obtain a target matrix after a final matrix multiplication operation is performed, which effectively uses the advantages of batch processing of the Montgomery modular multiplication and addition instruction, and improves the operation efficiency of a processor performing a matrix multiplication operation, so that the data processing efficiency is improved, and the operation time of performing modular multiplication operation on a matrix is saved.

### BRIEF DESCRIPTION OF DRAWINGS

The accompanying drawings described herein are intended to provide a further understanding of the present disclosure, and constitute a part of the present disclosure. The illustrative embodiments of the present disclosure and the descriptions thereof are used to explain the present disclosure, and do not constitute an improper limitation to the present disclosure. In the drawings:

FIG. 1 is a schematic diagram of a data processing scenario according to an embodiment of the present disclosure;

FIG. 2A is a flowchart of a data processing method according to an embodiment of the present disclosure;

FIG. 2B is a flowchart of an operation process according to an embodiment of the present disclosure;

FIG. 2C is a flowchart of another operation process according to an embodiment of the present disclosure;

FIG. 2D is a schematic diagram of an operation process according to an embodiment of the present disclosure;

FIG. 3A is a flowchart of another data processing method according to an embodiment of the present disclosure;

FIG. 3B is a schematic diagram of still another operation process according to an embodiment of the present disclosure;

FIG. 4 is a flowchart of still another data processing method according to an embodiment of the present disclosure;

FIG. 5 is a schematic diagram of a structure of a data processing apparatus according to an embodiment of the present disclosure; and

FIG. 6 is a block diagram of a structure of a computing device according to an embodiment of the present disclosure.

### DESCRIPTION OF EMBODIMENTS

In the following description, many specific details are explained in order for those skilled in the art to fully understand the present disclosure. However, the present disclosure can be implemented in many other manners different from those described herein. Those skilled in the art may make similar generalization without departing from the spirit of the present disclosure. Therefore, the present disclosure is not limited by the specific implementations disclosed below.

The terms used in one or more embodiments of the present disclosure are only for the purpose of describing specific embodiments, and are not intended to limit one or more embodiments of the present disclosure. Unless the context clearly dictates otherwise, the singular forms “a,” “an,” “said,” and “the” used in one or more embodiments of the present description and the appended claims are also intended to include the plural forms. It should also be understood that the term “and/or” used in one or more embodiments of the present disclosure refers to and includes any or all possible combinations of one or more associated listed items.

It should be understood that, although the terms first, second, and the like may be used to describe various information in one or more embodiments of the present description, such information should not be limited to these terms. These terms are only used to distinguish the same type of information from each other. For example, without departing from the scope of one or more embodiments of the present description, first may also be referred to as second. Similarly, second may also be referred to as first. Depending on the context, the word “if” as used herein may be interpreted as “when” or “in the case that” or “in response to a determination.”

First, the terms involved in one or more embodiments of the present disclosure are explained below.

Blockchain refers to a new decentralized distributed data system, and a database with data “hashing verification” function. Block is a data block. Data blocks are combined into a chain structure according to a time sequence, and reliability of a database is collectively maintained in a distributed accounting manner by using a cryptography algorithm. All data blocks are connected in a time sequence, thereby forming a blockchain, which combines various technologies such as a consensus mechanism, an encryption algorithm, and point-to-point transmission.

Poseidon Hash refers to a new Hash function applied to a zero-knowledge proof system. Compared with Pedersen Hash, the constraint complexity of the zero-knowledge proof system using Poseidon can be reduced by 8 times.

Zero-knowledge proof means that a prover can convince a verifier that an assertion is correct without providing any useful information to the verifier.

File coin is a distributed storage solution initiated by Protocol Labs, and a blockchain implementation of the IPFS interstellar file system.

Instruction is a bridge between software and hardware. The design of the instruction determines the design complexity and performance of software and hardware.

Dedicated instruction is an instruction of a dedicated processor designed for a specific application field, and can accelerate an algorithm in the specific application field. The dedicated instruction in the embodiment of the present disclosure is specially designed for a Poseidon Hash algorithm.

Montgomery modular multiplication and addition instruction is an instruction specially designed for the Poseidon Hash algorithm, and simultaneously completes multiplication and addition operations of a Montgomery domain.

As the latest hash function, Poseidon Hash is widely used in the fields of blockchain and privacy protection. For example, the IPFS/Filecoin blockchain and Loopring projects use Poseidon Hash as a core hash function to improve security thereof. A core calculation in the Poseidon Hash is a matrix multiplication operation. How to improve the execution efficiency of matrix multiplication is the main problem, and how to use a pipelined modular multiplication operational unit and related instructions is the key to improving performance. Therefore, embodiments of the present disclosure provide a high-performance matrix modular multiplication algorithm based on Montgomery modular multiplication and addition, which effectively uses the advantages of batch processing of dedicated instructions, and greatly improves the operating efficiency of the matrix multiplication operational unit.

In the present disclosure, a data processing method is provided, and the present disclosure further relates to a data processing apparatus, a computing device, and a computer-readable storage medium, which will be described in detail one by one in the following embodiments.

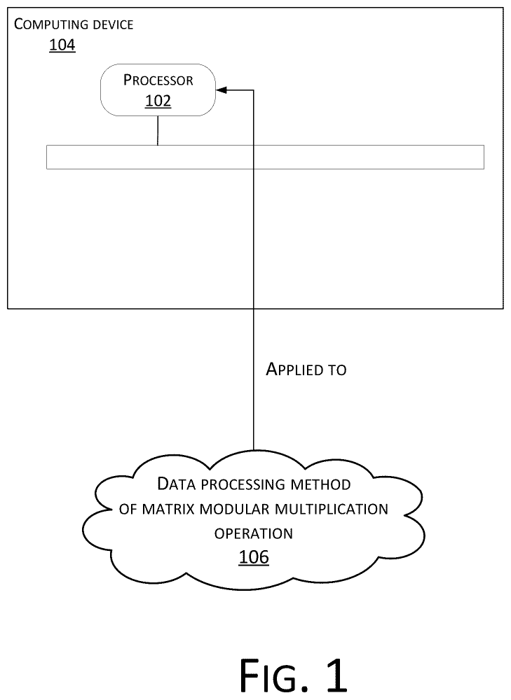

FIG. 1 is a schematic diagram of a data processing scenario according to an embodiment of the present disclosure. As shown in FIG. 1, the processor is a processor that performs a matrix multiplication operation. By adopting the data processing method of matrix multiplication operation provided by the embodiment of the present disclosure, the operation efficiency of the processor performing matrix multiplication operation can be improved, so that the data processing efficiency of the processor is improved, and the operation time of the matrix multiplication operation is saved.

A Poseidon Hash (Precommit2) stage in Filecoin has an execution time on a monolithic processor of around 20 minutes. The embodiments of the present disclosure provide a high-performance processing method for matrix multiplication based on Montgomery modular multiplication and addition, so that the execution time of a Precommit2 stage on a monolithic processor can be shortened to about 10 minutes. The core calculation of a Poseidon Hash algorithm is a matrix multiplication algorithm, and improving the performance of the matrix multiplication algorithm plays a key role in improving the operation efficiency of the processor.

It should be noted that the data processing method according to an embodiment of the present disclosure is applied to a matrix multiplication algorithm, and the matrix multiplication algorithm is currently involved in many scenarios, such as the Poseidon Hash algorithm in the fields of blockchain and privacy protection. In the field of privacy protection, when the data information of a user is encrypted, a matrix multiplication algorithm may be involved, that is, the data information of the user can be converted into a matrix, and then the encryption is performed in a matrix multiplication manner, so that the data security of the user is protected; or when a private picture uploaded by the user is encrypted, a matrix multiplication algorithm may also be involved, that is, data in the picture uploaded by the user can be extracted, the data of the picture are converted into a matrix, and then encryption is performed in a matrix multiplication manner, so that the data security of the user is protected. Therefore, matrix multiplication operations are involved in different scenarios. The data processing method according to an embodiment of the present disclosure can be applied to matrix multiplication operations involved in various scenarios.

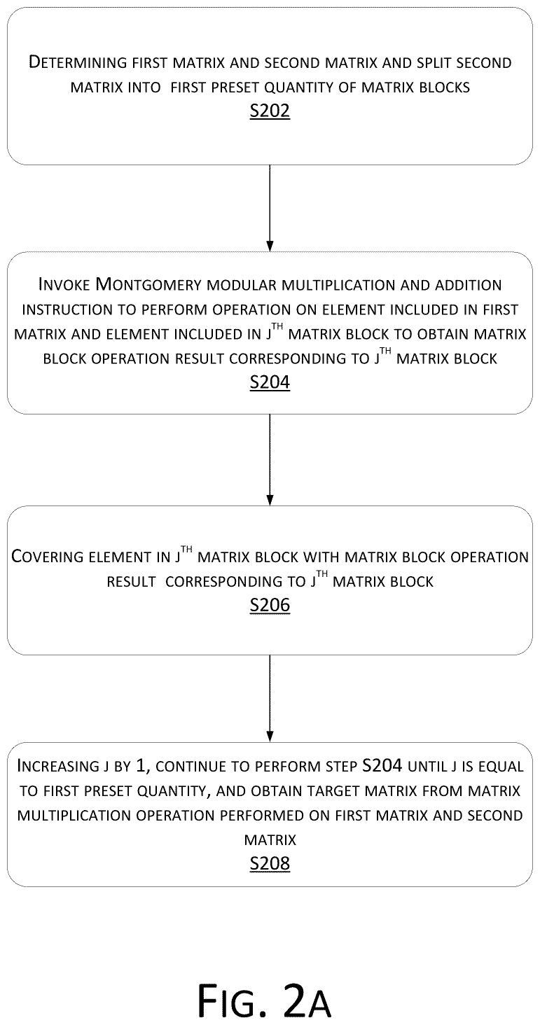

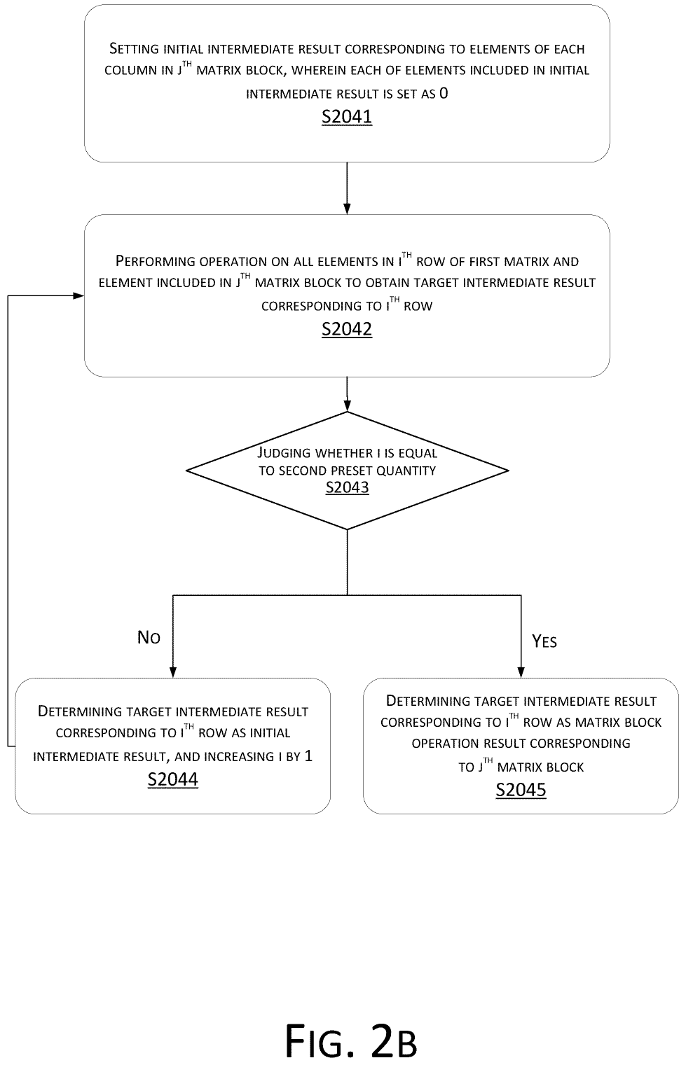

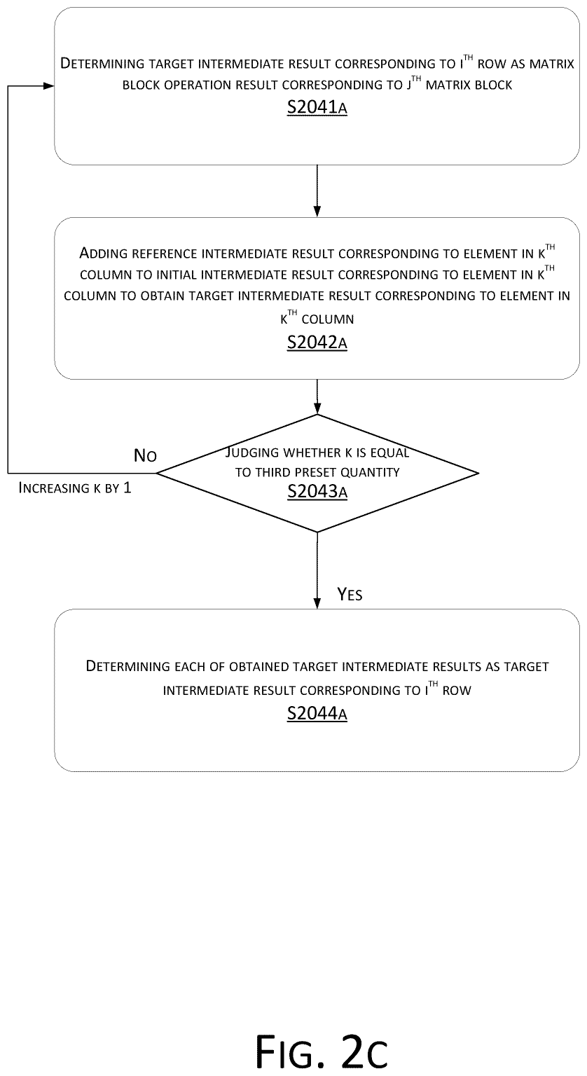

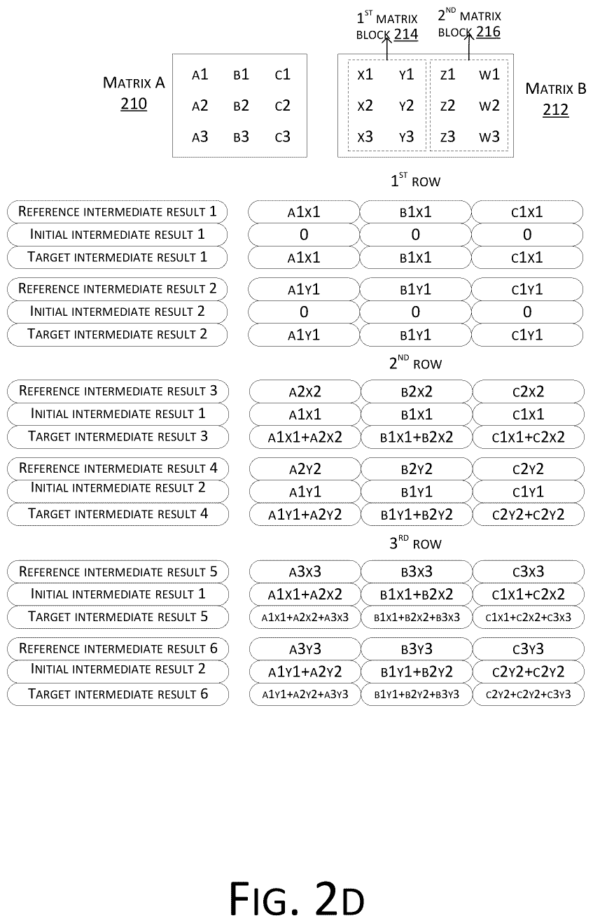

FIG. 2A shows a flowchart of a data processing method according to an embodiment of the present disclosure, which comprises steps S1 to S4.

Step S202: determining a first matrix and a second matrix, and splitting the second matrix into a first preset quantity of matrix blocks.

For example, the first matrix and the second matrix may refer to two matrices waiting for a matrix multiplication operation, and both the first matrix and the second matrix are stored in columns. It should be noted that the core calculation in Poseidon Hash is a matrix multiplication operation, and may be a matrix multiplication operation based on a large integer modular multiplication, or may be a sparse matrix modular multiplication operation. In other words, an element included in the matrix to be subjected to the matrix multiplication operation may be a large integer, that is, a length occupied by this element is relatively long, for example, an element included in the matrix that needs to be subjected to the matrix multiplication operation may be 256-bit data. In addition, the first matrix and the second matrix may be small-scale matrices, that is, the rows and columns of the first matrix and the second matrix may be smaller than a preset threshold. The matrix multiplication refers to an operation of performing modular multiplication on two matrices.

In addition, since the two matrices can be subjected to multiplication operation, the columns of the first matrix need to be equal to the rows of the second matrix. In the embodiments of the present disclosure, the second matrix is split into a first preset quantity of matrix blocks, and then an operation is performed on each row of the data blocks obtained by splitting the first matrix and the second matrix in sequence, so that the rows of the first matrix are also the same as the rows of the second matrix. In other words, the first matrix is a square matrix comprising the same rows and columns, and the rows of the second matrix are the same as the rows of the first matrix.

For example, the determined first matrix is a 12×12 matrix, and the second matrix is a 12×32 matrix.

It should be noted that the processor that performs Montgomery modular multiplication and addition can be a fully pipelined operational unit. The efficient use of the operational unit requires sufficient multiplication and addition operations to be executed in parallel, and an original matrix multiplication algorithm needs to be optimized to use this property of the operational unit, thereby improving the operating efficiency of the operational unit.

In an optional implementation of this embodiment, when the matrix multiplication operation is performed on the first matrix and the second matrix, after the second matrix is split into a plurality of matrix blocks, the first matrix may be operated separately with each of the matrix blocks obtained by splitting. When the first matrix and the split matrix blocks are operated, the matrix blocks may be stored in a buffer space. In order to improve the space utilization of the buffer space and save the storage resource overhead, it is necessary to store as many columns of elements as possible in the buffer space, that is, it may be determined, according to the size of the buffer space, how many data blocks the second matrix is to be split into, and then the second matrix is split into a first preset quantity of matrix blocks. The implementation process can be as follows:
determining a buffer capacity of the buffer space;
determining a quantity of stored columns of the buffer space for the second matrix according to the buffer capacity;
determining the first preset quantity according to a total quantity of columns of the second matrix and the quantity of stored columns; and
splitting the second matrix into the first preset quantity of matrix blocks, wherein each of the matrix blocks comprises elements in a second preset quantity of columns.

For example, the buffer space is used to temporarily store matrix blocks, and the buffer capacity refers to the size of the buffer space. According to the size of the buffer space, a maximum quantity of columns of the second matrix that the buffer space can store can be determined. That is, in the buffer space, for a quantity of stored columns of the second matrix, a total quantity of columns of the second matrix is divided by the quantity of stored columns to obtain a quantity of the data blocks which need to be split by the second matrix.

For example, the second matrix is a 12×32 matrix, that is, the second matrix comprises 32 columns of elements. Assuming that a quantity of stored columns in the buffer space for the second matrix is (that is, the size of the buffer space can store at most) 2 columns of elements, the second matrix can be split into 16 matrix blocks in this case. Alternatively, assuming that a quantity of stored columns in the buffer space for the second matrix is 4 columns of elements, the second matrix can be split into 8 matrix blocks in this case.

In an example implementation of this embodiment, after the second matrix is split into the first preset quantity of matrix blocks, the matrix blocks to be operated with the first matrix can be stored in the buffer space for subsequent operations. That is, before invoking a Montgomery modular multiplication and addition instruction to perform an operation on an element included in the first matrix and an element included in a j^{th} matrix block to obtain a matrix block operation result corresponding to the j^{th} matrix block, the data processing method further comprises:
storing the j^{th} matrix block into the buffer space.

In the embodiments of the present disclosure, after the first matrix and the second matrix are determined, the second matrix can be split into a first preset quantity of matrix blocks, and then the matrix blocks to be operated can be stored in the buffer space, so that the first matrix can be operated separately with the data block subsequently. The original element in the matrix block can be covered with a result of the operation with the first matrix, that is, the data block stored in the buffer space is updated, and the data stored in the buffer space is continuously used, which makes full use of the reusability of data in the matrix multiplication algorithm. A quantity of columns in the matrix blocks stored in the buffer space is the maximum quantity of matrix columns which can be stored in the buffer space, so that the saving of the storage resource overhead is maximized.

Step S204: invoking a Montgomery modular multiplication and addition instruction to perform an operation on an element included in the first matrix and an element included in a j^{th} matrix block to obtain a matrix block operation result corresponding to the j^{th} matrix block. For example, j starts from 1.

The Montgomery modular multiplication and addition instruction is a predefined dedicated instruction, which can implement the multiplication and addition operations of the Montgomery domain simultaneously. The Montgomery domain is formed by converting a constant domain through Montgomery modular multiplication calculation. It should be noted that modular multiplication requires multiplication and division operations, and the operation is complicated. The Montgomery algorithm converts modular multiplication into multiplication, addition, displacement, and other operations.

For example, on the basis of splitting the second matrix into a first preset quantity of matrix blocks, further, a Montgomery modular multiplication and addition instruction can be invoked to perform an operation on an element included in the first matrix and an element included in a j^{th} matrix block to obtain a matrix block operation result corresponding to the j^{th} matrix block. For example, j starts from 1. In addition, the Montgomery modular multiplication and addition instruction is a predefined dedicated instruction, which can implement the multiplication and addition operations of the Montgomery domain simultaneously.

In an example implementation of this embodiment, the Montgomery modular multiplication and addition instruction can be customized in advance to implement an operation before the first matrix and each of the matrix blocks. That is, before the Montgomery modular multiplication and addition instruction is invoked to perform an operation on an element included in the first matrix and an element included in a j^{th} matrix block to obtain a matrix block operation result corresponding to the j^{th} matrix block, the data processing method further comprises:

setting the Montgomery modular multiplication and addition instruction, wherein the Montgomery modular multiplication and addition instruction comprises an operation type identifier, a first source operand, a second source operand, a third source operand, and a target operand.

For example, the operation type identifier can be an operation type to be implemented by the Montgomery modular multiplication and addition instruction, for example, the operation type identifier can be multiplication and addition operation, multiplication operation, and addition operation. The first source operand, the second source operand, and the third source operand can be a data source requiring an operation performed by a Montgomery modular multiplication and addition instruction. The target operand may be a result obtained by performing a corresponding operation, i.e., an operation result.

In the present disclosure, a dedicated instruction for performing an operation on the first matrix and the second matrix, that is, a Montgomery modular multiplication and addition instruction, may be customized in advance. Subsequently, the multiplication and addition operations of the Montgomery domain can be simultaneously implemented through a customized Montgomery modular multiplication and addition instruction to perform a complex operation between an element included in the first matrix and an element included in a j^{th} matrix block, so as to obtain a target matrix after the final matrix multiplication operation, which effectively uses the advantages of batch processing of the Montgomery modular multiplication and addition instruction, and improves the operation efficiency of a processor performing a matrix multiplication operation, so that the data processing efficiency is improved, and the operation time of performing modular multiplication operation on a matrix is saved.

In an example implementation of this embodiment, an implementation process of invoking a Montgomery modular multiplication and addition instruction to perform an operation on an element included in the first matrix and an element included in a j^{th} matrix block to obtain a matrix block operation result corresponding to the j^{th} matrix block can be as follows:
reading the j^{th} matrix block from the buffer space; and
invoking the Montgomery modular multiplication and addition instruction to perform an operation on the element comprised in the first matrix and an element comprised in the read j^{th} matrix block to obtain the matrix block operation result corresponding to the j^{th} matrix block.

It should be noted that after the second matrix is split into the first preset quantity of matrix blocks, the matrix blocks to be operated with the first matrix can be stored in the buffer space. Therefore, when the first matrix and a matrix block need to be operated, the corresponding data block can be obtained from the buffer space, and then the subsequent operation is performed.

FIG. 2B is a flowchart of an operation process according to an embodiment of the present disclosure. In an example implementation of this embodiment, in a process of performing an operation on an element included in the first matrix and an element included in a j^{th} matrix block, the element included in the first matrix and the element included in the j^{th} matrix block can be operated row by row, as shown in FIG. 2B, the first matrix comprises elements in a second preset quantity of rows; and
correspondingly, an implementation process of the invoking a Montgomery modular multiplication and addition instruction to perform an operation on an element included in the first matrix and an element included in a j^{th} matrix block to obtain a matrix block operation result corresponding to the j^{th} matrix block may comprise the following steps S2041 to S2045:
Step S2041: setting an initial intermediate result corresponding to elements of each column in the j^{th} matrix block, wherein each of the elements included in the initial intermediate result is set as 0.

Step S2042: performing an operation on all elements in an i^{th} row of the first matrix and the element included in the j^{th} matrix block to obtain a target intermediate result corresponding to the i^{th} row. For example, i starts from 1.

Step S2043: judging whether i is equal to the second preset quantity; if not, performing step S2044; and if so, performing step S2045.

Step S2044: determining the target intermediate result corresponding to the i^{th} row as the initial intermediate result, increasing i by 1, and continuing to perform the step S2042.

Step S2045: determining the target intermediate result corresponding to the i^{th} row as the matrix block operation result corresponding to the j^{th} matrix block.

It should be noted that, for a 1^{st} row, an element in the 1^{st} row of the first matrix and the j^{th} matrix block are operated to obtain a target intermediate result corresponding to the 1^{st} row. Since no data is present before the 1^{st} row, there is no need to combine with the previous data, and an element included in an initial intermediate result may be set as 0. Then, the target intermediate result obtained in the 1^{st} row may be combined with the initial intermediate result, and the target intermediate result corresponding to the 1^{st} row may be determined as the initial intermediate result. That is, the initial intermediate result is updated according to the target intermediate result corresponding to the 1^{st} row, so that the operation result of the 1^{st} row can be combined when the 2^{nd} row is operated subsequently. Therefore, for the 2^{nd} row, an element in the 2^{nd} row of the first matrix and the j^{th} matrix block are operated to obtain a target intermediate result corresponding to the 2^{nd} row. Then, the initial intermediate result is updated according to the target intermediate result corresponding to the 2^{nd} row until a target intermediate result corresponding to the last row is obtained, namely a matrix block operation result corresponding to the j^{th} matrix block.

In another possible implementation, the 1^{st} row of the first matrix and the j^{th} matrix block are directly operated without presetting an initial intermediate result to obtain a target intermediate result corresponding to the 1^{st} row. In this case, the target intermediate result corresponding to the 1^{st} row may be set as the initial intermediate result, then the 2^{nd} row of the first matrix and the j^{th} matrix block are operated to obtain a target intermediate result corresponding to the 2^{nd} row, and the initial intermediate result is updated according to the target intermediate result corresponding to the 2^{nd} row so as to perform subsequent operation.

FIG. 2C is a flowchart of another operation process according to an embodiment of the present disclosure. In an example implementation of this embodiment, in a process of performing an operation on all elements included in an i^{th} row of the first matrix and an element included in the j^{th} matrix block, the elements included in the first matrix and the element included in the j^{th} matrix block can be operated column by column, as shown in FIG. 2C, each of the matrix blocks comprises elements in a third preset quantity of columns; and correspondingly, an implementation process of the performing an operation on all elements in an i^{th} row of the first matrix and the element included in the j^{th} matrix block to obtain a target intermediate result corresponding to the i^{th} row can be as follows:
S2041A: multiplying all the elements in the i^{th} row of the first matrix by an element in an i^{th} row and a k^{th} column in the j^{th} matrix block to obtain a reference intermediate result corresponding to the element in the k^{th} column. For example, k starts from 1;
S2042A: adding the reference intermediate result corresponding to the element in the k^{th} column to an initial intermediate result corresponding to the element in the k^{th} column to obtain a target intermediate result corresponding to the element in the k^{th} column;
S2043A: judging whether k is equal to the third preset quantity; if not, increasing k by 1 and continuing to perform the step S2041A; and if so, performing step S2044A; and S2044A: determining each of the obtained target intermediate results as the target intermediate result corresponding to the i^{th} row.

It should be noted that, for a row, all elements in this row may be multiplied by the element in a 1^{st} column and this row in the j^{th} matrix block to obtain a reference intermediate result corresponding to the element in the 1^{st} column. Then, the reference intermediate result corresponding to the element in the 1^{st} column is added to an initial intermediate result corresponding to the element in the 1^{st} column to obtain a target intermediate result corresponding to the element in the 1^{st} column, until the element in each of the columns in the matrix block is operated, and a corresponding target intermediate result can be obtained. In this case, the obtained target intermediate result corresponding to the element in each of the columns is the target intermediate result corresponding to this row.

In addition, for a matrix block, a corresponding initial intermediate result can be preset for an element in each of the columns of this matrix block, so that a reference intermediate result corresponding to the element in the k^{th} column is added to an initial intermediate result corresponding to the element in the k^{th} column to obtain a target intermediate result corresponding to the element in the k^{th} column.

Furthermore, in a process of determining the target intermediate result corresponding to the i^{th} row as the initial intermediate result, a target intermediate result corresponding to the i^{th} row and the k^{th} column can be determined as the initial intermediate result corresponding to the k^{th} column. That is, a target intermediate result corresponding to a column is used to update the initial intermediate result corresponding to an element in this column.

For example, FIG. 2D is a schematic diagram of an operation process according to an embodiment of the present disclosure. As shown in FIG. 2D, the first matrix is a 3×3 matrix A 210, the second matrix is a 3×4 matrix B 212, and the matrix B 212 is split into 2 matrix blocks, such as the first matrix block 214 and the second matrix block 216. Each matrix block comprises 2 columns of elements. That is, the first preset quantity is 2, the second preset quantity is 3, and the third preset quantity is 2. For the first matrix block 214, an initial intermediate result 1 corresponding to an element in the 1^{st} column of the matrix block is preset, an initial intermediate result 2 corresponding to an element in the 2^{nd} column of the matrix block is preset, and each of the elements included in the initial intermediate result is set as 0.

For an element in the 1^{st} row (that is, i is equal to 1), k is made to be equal to 1, all elements in the 1^{st} row of the matrix A are multiplied by the element in the 1^{st} row and the 1^{st} column in the matrix block to obtain a reference intermediate result 1 corresponding to the element in the 1^{st} column, and the reference intermediate result 1 is added to the initial intermediate result 1 to obtain a target intermediate result 1. Since the current k is equal to 1 and is not equal to the third preset quantity, k is increased by 1, all elements in the 1^{st} row of the matrix A are multiplied by the element in the 1^{st} row and the 2nd column in the matrix block to obtain a reference intermediate result 2 corresponding to the element in the 2^{nd} column, and the reference intermediate result 2 is added to the initial intermediate result 2 to obtain a target intermediate result 2. Since the current k is equal to the third preset quantity, the obtained target intermediate result 1 and the target intermediate result 2 are determined as the target intermediate results corresponding to the 1^{st} row.

Since i is equal to 1 and is not equal to the second preset quantity in this case, the determined target intermediate result corresponding to the 1^{st} row is determined as the initial intermediate result. That is, the target intermediate result corresponding to the 1^{st} row and the 1^{st} column is determined as the initial intermediate result corresponding to the element in the 1^{st} column, and the target intermediate result corresponding to the 1^{st} row and the 2^{nd} column is determined as the initial intermediate result corresponding to the element in the 2^{nd} column. In this case, the initial intermediate result 1 is the target intermediate result 1, and the initial intermediate result 2 is the target intermediate result 2. Then, i is increased by 1, all elements in the 2^{nd} row of the matrix A are multiplied by the element in the 2^{nd} row and the 1^{st} column in the matrix block to obtain a reference intermediate result 3 corresponding to the element in the 1^{st} column, and the reference intermediate result 3 is added to the initial intermediate result 1 (the target intermediate result 1) to obtain a target intermediate result 3. Since the current k is equal to 1 and not equal to the third preset quantity, k is increased by 1, all elements in the 2^{nd} row of the matrix A are multiplied by the element in the 2nd row and the 2nd column in the matrix block to obtain a reference intermediate result 4 corresponding to the element in the 2^{nd} column, and the reference intermediate result 4 is added to the initial intermediate result 2 (the target intermediate result 2) to obtain a target intermediate result 4. Since the current k is equal to the third preset quantity, the obtained target intermediate result 3 and the target intermediate result 4 are determined as the target intermediate results corresponding to the 2^{nd} row.

Since the current i is equal to 2 and is not equal to the second preset quantity in this case, the determined target intermediate result corresponding to the 2^{nd} row is determined as the initial intermediate result. That is, the target intermediate result corresponding to the 2^{nd} row and the 1^{st} column is determined as the initial intermediate result corresponding to the element in the 1^{st} column, and the target intermediate result corresponding to the 2^{nd} row and the 2^{nd} column is determined as the initial intermediate result corresponding to the element in the 2^{nd} column. In this case, the initial intermediate result 1 is the target intermediate result 3, and the initial intermediate result 2 is the target intermediate result 4. Then, i is increased by 1, all elements in the 3^{rd} row of the matrix A are multiplied by the element in the 3^{rd} row and the 1^{st} column in the matrix block to obtain a reference intermediate result 5 corresponding to the element in the 1^{st} column, and the reference intermediate result 5 is added to the initial intermediate result 1 (the target intermediate result 3) to obtain a target intermediate result 5. Since the current k is equal to 1 and not equal to the third preset quantity, k is increased by 1, all elements in the 3^{rd} row of the matrix A are multiplied by the element in the 3^{rd} row and the 2^{nd} column in the matrix block to obtain a reference intermediate result 6 corresponding to the element in the 2^{nd} column, and the reference intermediate result 6 is added to the initial intermediate result 2 (the target intermediate result 4) to obtain a target intermediate result 6. Since the current k is equal to the third preset quantity, the obtained target intermediate result 5 and the target intermediate result 6 are determined as the target intermediate results corresponding to the 3^{rd} row.

Since the current i is equal to the second preset quantity in this case, the target intermediate result corresponding to the 3^{rd} row is determined as a matrix block operation result corresponding to the 1^{st} matrix block. That is, the matrix block operation result corresponding to the 1^{st} matrix block in this case is the target intermediate result 5 and the target intermediate result 6.

The above-described operation is repeated for the second matrix block 216, and a matrix block operation result corresponding to the second matrix block 216 can be obtained, so that a target matrix after the matrix multiplication operation is obtained.

In an example implementation of this embodiment, the Montgomery modular multiplication and addition instruction is customized in advance, so that each of the above-described operation processes can be implemented by invoking a Montgomery modular multiplication and addition instruction. That is, an implementation process of the performing an operation on all elements in an i^{th} row of the first matrix and the element included in the j^{th} matrix block to obtain a target intermediate result corresponding to the i^{th} row can be as follows:
determining the operation type identifier, the first source operand, the second source operand, and the third source operand according to an operation process of all the elements in the i^{th} row of the first matrix and the element comprised in the j^{th} matrix block;
invoking the Montgomery modular multiplication and addition instruction to perform the steps S2041A and 52042A according to the operation type identifier, the first source operand, the second source operand, and the third source operand; and
taking the target operand obtained after executing the Montgomery modular multiplication and addition instruction as the target intermediate result.

It should be noted that all elements in the i^{th} row of the first matrix and the element included in the j^{th} matrix block are to be operated. Since the operation process of all elements in the i^{th} row of the first matrix and the element included in the j^{th} matrix block comprises the above-described steps S2041A and 52042A, it is needed to determine parameters required in the Montgomery modular multiplication and addition instruction, i.e., the operation type identifier, the first source operand, the second source operand, and the third source operand, according to the steps S2041A and 52042A. After the operation type identifier, the first source operand, the second source operand, and the third source operand are determined, the Montgomery modular multiplication and addition instruction may be invoked to perform operations of the steps S2041A and S2042A according to the operation type identifier, the first source operand, the second source operand, and the third source operand to obtain a corresponding target intermediate result.

In an example implementation of this embodiment, an implementation process of the determining the operation type identifier, the first source operand, the second source operand, and the third source operand according to an operation process of all the elements in the i^{th} row of the first matrix and the element included in the j^{th} matrix block can be as follows:
determining the operation type identifier as a multiplication and addition operation according to the steps S2041A and S2042A comprised in the operation process of all the elements in the i^{th} row of the first matrix and the element comprised in the j^{th} matrix block; and
determining the initial intermediate result as the first source operand, determining all the elements in the i^{th} row of the first matrix as the second source operands, and determining the element in the i^{th} row and the k^{th} column in the j^{th} matrix block as the third source operand.

It should be noted that, since the above-described step S2041A is an operation step corresponding to a multiplication operation, and the step S2042A is an operation step corresponding to an addition operation, an operation process of all the elements in the i^{th} row of the first matrix and the element included in the j^{th} matrix block comprises the multiplication operation and the addition operations. In this case, the operation type identifier may be determined as a multiplication and addition operation. In addition, the step S2041A is to multiply all elements in the i^{th} row of the first matrix by the element in the i^{th} row and the k^{th} column in the j^{th} matrix block. In this case, all elements in the i^{th} row of the first matrix may be determined as the second source operand, and the element in the i^{th} row and the k^{th} column in the j^{th} matrix block may be determined as the third source operand. In the step S2042A, a result of the step S2041A is added to the initial intermediate result, so that the initial intermediate result may be determined as the first source operand, and the target operand obtained after the Montgomery modular multiplication and addition instruction is executed may be determined as the target intermediate result corresponding to the i^{th} row.

Embodiments of the present disclosure provide a high-performance matrix multiplication algorithm based on Montgomery modular multiplication and addition. The second matrix is split into a plurality of matrix blocks, and the matrix blocks are separately operated with the first matrix to obtain a target matrix after the matrix multiplication operation, which simplifies an operation process of the matrix multiplication operation on the matrix and reduces operation complexity. In addition, a dedicated Montgomery modular multiplication and addition instruction may be customized in advance, and a complex operation between an element included in the first matrix and an element included in a j^{th} matrix block can be implemented by invoking the Montgomery modular multiplication and addition instruction, so as to obtain a target matrix after a final Montgomery modular multiplication and addition operation is performed, which effectively uses the advantages of batch processing of the Montgomery modular multiplication and addition instruction, and improves the operation efficiency of a processor performing a matrix multiplication operation, so that the data processing efficiency is improved, and the operation time of performing modular multiplication operation on a matrix is saved.

Step S206: covering the element in the j^{th} matrix block with the matrix block operation result corresponding to the j^{th} matrix block.

For example, on the basis of invoking the Montgomery modular multiplication and addition instruction to perform an operation on an element included in the first matrix and an element included in a j^{th} matrix block to obtain a matrix block operation result corresponding to the j^{th} matrix block, further, the element in the j^{th} matrix block can be covered with the matrix block operation result corresponding to the j^{th} matrix block.

It should be noted that the determined matrix block operation result corresponding to the j^{th} matrix block may comprise a target intermediate result corresponding to an element in each column in the matrix block, and therefore, when the element in the j^{th} matrix block can be covered with the matrix block operation result corresponding to the j^{th} matrix block, the target intermediate result that corresponds to the element in the k^{th} column in the matrix block operation result corresponding to the j^{th} matrix block can be used to replace an element in the k^{th} column in the j^{th} matrix block.

Following the above example, as shown in FIG. 2D, for the 1^{st} matrix block, the obtained matrix block operation results are the target intermediate result 5 and the target intermediate result 6, wherein the target intermediate result 5 is a target intermediate result corresponding to an element in the 1^{st} column in the 1^{st} matrix block, and the target intermediate result 6 is a target intermediate result corresponding to an element in the 2nd column in the 1^{st} matrix block. Therefore, in this case, the element in the 1^{st} column in the 1^{st} matrix block may be covered with the target intermediate result 5, and the element in the 2^{nd} column in the 1^{st} matrix block may be covered with the target intermediate result 6, so that the updated 1^{st} matrix block is obtained.

Embodiments of the present disclosure provide a high-performance matrix multiplication algorithm based on Montgomery modular multiplication and addition, which can use an operation result of the matrix block and the first matrix to cover the original element in the matrix block, so as to obtain the target matrix after the matrix multiplication operation, which simplifies an operation process of the matrix multiplication operation on the matrix and reduces operation complexity; and the algorithm is simple, which can be applied to a variety of small-scale matrix multiplication operations, and improves the operation efficiency of a processor performing a matrix multiplication operation, so that the data processing efficiency is improved, and the operation time of performing modular multiplication operation on a matrix is saved.

Step S208: increasing j by 1, continuing to perform the step S204 until j is equal to the first preset quantity, and obtaining a target matrix from the matrix multiplication operation performed on the first matrix and the second matrix.

For example, on the basis of covering the element in the j^{th} matrix block with the matrix block operation result corresponding to the j^{th} matrix block, further, j can be increased by 1, the above-described step S2 is continued to be performed until j is equal to the first preset quantity, and a target matrix from the matrix multiplication operation performed on the first matrix and the second matrix is obtained.

It should be noted that, after the element in the 1^{st} matrix block is covered to obtain the updated 1^{st} matrix block, the above-described operation process may be repeatedly performed on the 2^{nd} matrix block to cover the element in the 2^{nd} matrix block so as to obtain the updated 2^{nd} matrix block until all the matrix blocks obtained by splitting are completely covered. This indicates that the operation between the first matrix and the second matrix is completed, and the obtained updated matrix blocks are merged to be the target matrix from the matrix multiplication operation performed on the first matrix and the second matrix.

An embodiment of the present disclosure provides a data processing method, which comprises: determining a first matrix and a second matrix, and splitting the second matrix into a first preset quantity of matrix blocks; invoking a Montgomery modular multiplication and addition instruction to perform an operation on an element included in the first matrix and an element included in a j^{th} matrix block to obtain a matrix block operation result corresponding to the j^{th} matrix block, and covering the element in the j^{th} matrix block with the matrix block operation result corresponding to the j^{th} matrix block; and increasing j by 1, continuing to perform the above-described step of obtaining the matrix block operation result until j is equal to the first preset quantity, and obtaining a target matrix from the matrix multiplication operation performed on the first matrix and the second matrix. In this way, a high-performance matrix modular multiplication algorithm based on Montgomery modular multiplication and addition is provided, wherein a second matrix is split into a plurality of matrix blocks, and then a result of the operation with the first matrix is used to cover an original element in the matrix block to obtain a target matrix after the matrix multiplication operation, which simplifies an operation process of the matrix multiplication operation and reduces operation complexity. In addition, a complex operation between an element included in the first matrix and an element included in a j^{th} matrix block can be implemented by invoking a Montgomery modular multiplication and addition instruction, so as to obtain a target matrix after a final matrix multiplication operation is performed, which effectively uses the advantages of batch processing of the Montgomery modular multiplication and addition instruction, and improves the operation efficiency of a processor performing a matrix multiplication operation, so that the data processing efficiency is improved, and the operation time of performing modular multiplication operation on a matrix is saved.

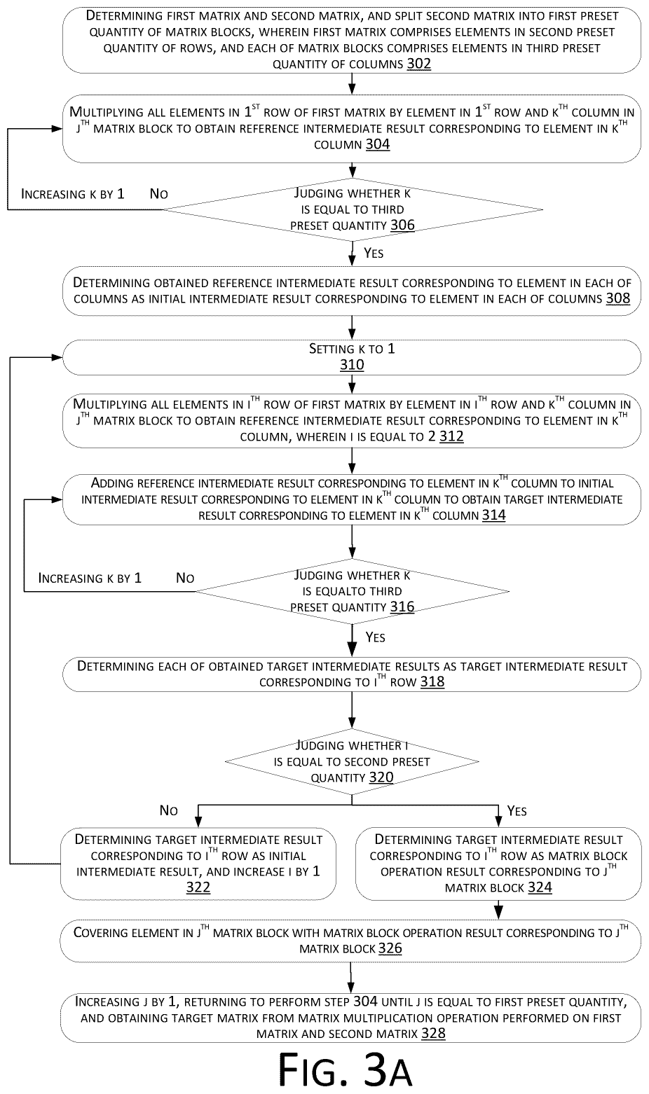

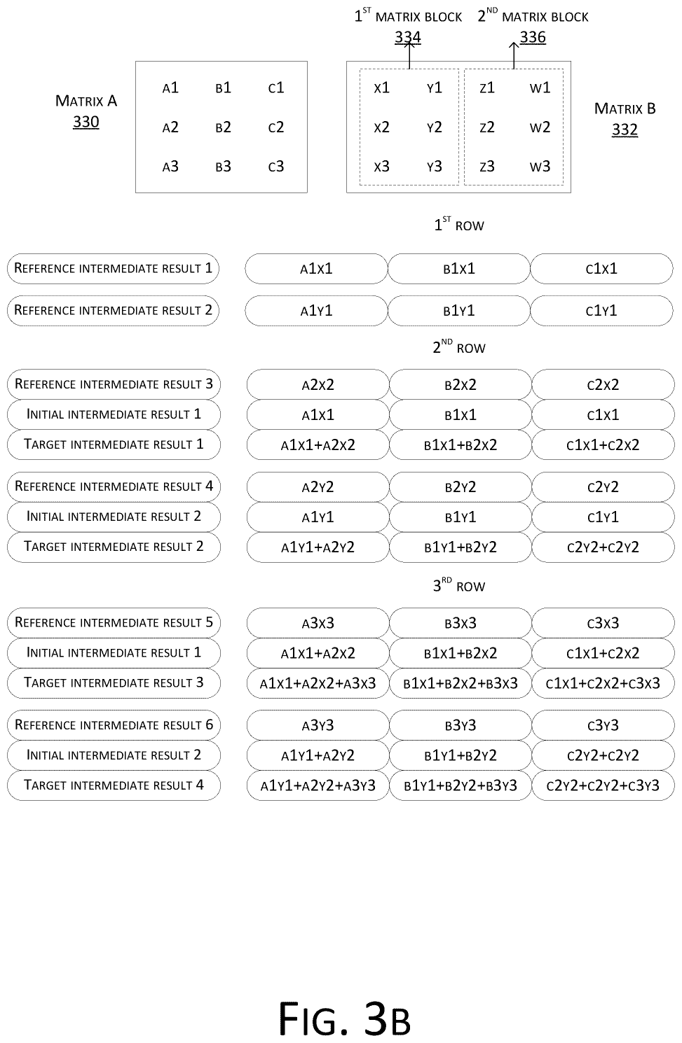

FIG. 3A shows a flowchart of another data processing method according to an embodiment of the present disclosure. As shown in FIG. 3A, the method comprises:

Step 302: determining a first matrix and a second matrix, and splitting the second matrix into a first preset quantity of matrix blocks, wherein the first matrix comprises elements in a second preset quantity of rows, and each of the matrix blocks comprises elements in a third preset quantity of columns.

Step 304: multiplying all elements in the 1^{st} row of the first matrix by the element in a 1^{st} row and a k^{th} column in the j^{th} matrix block to obtain a reference intermediate result corresponding to the element in the k^{th} column. For example, k starts from 1, and j starts from 1;

Step 306: judging whether k is equal to the third preset quantity; if not, increasing k by 1 and continuing to perform the step 304; and if so, performing step 308.

Step 308: determining the obtained reference intermediate result corresponding to an element in each of the columns as an initial intermediate result corresponding to the element in each of the columns.

Step 310: setting k to 1.

Step 312: multiplying all the elements in the i^{th} row of the first matrix by the element in the i^{th} row and the k^{th} column in the j^{th} matrix block to obtain a reference intermediate result corresponding to the element in the k^{th} column, wherein i is equal to 2.

Step 314: adding the reference intermediate result corresponding to the element in the k^{th} column to an initial intermediate result corresponding to the element in the k^{th} column to obtain a target intermediate result corresponding to the element in the k^{th} column.

Step 316: judging whether k is equal to the third preset quantity; if not, increasing k by 1 and continuing to perform the step 312; and if so, performing step 318.

Step 318: determining each of the obtained target intermediate results as the target intermediate result corresponding to the i^{th} row.

Step 320: judging whether i is equal to the second preset quantity; if not, performing step 322; and if so, performing step 324.

Step 322: determining the target intermediate result corresponding to the i^{th} row as the initial intermediate result, increasing i by 1, and continuing to perform the step 310.

Step 324: determining the target intermediate result corresponding to the i^{th} row as the matrix block operation result corresponding to the j^{th} matrix block.

Step 326: covering the element in the j^{th} matrix block with the matrix block operation result corresponding to the j^{th} matrix block.

Step 328: increasing j by 1, returning to perform the step 304 until j is equal to the first preset quantity, and obtaining a target matrix from the matrix multiplication operation performed on the first matrix and the second matrix.

It should be noted that, in the description of this embodiment, the 1^{st} row of the first matrix and the j^{th} matrix block are directly operated without presetting an initial intermediate result to obtain a target intermediate result corresponding to the 1^{st} row, then a target intermediate result corresponding to the 1^{st} row is set as the initial intermediate result, the 2^{nd} row of the first matrix and the j^{th} matrix block are then operated to obtain a target intermediate result corresponding to the 2^{nd} row, and the initial intermediate result is updated according to the target intermediate result corresponding to the 2^{nd} row. By analogy, the initial intermediate result is updated according to the target intermediate result corresponding to each row until the target intermediate result corresponding to the last row is obtained, and the target intermediate result corresponding to the last row is determined as the matrix operation result corresponding to the matrix block.

For example, FIG. 3B is a schematic diagram of another operation process according to an embodiment of the present disclosure. As shown in FIG. 3B, the first matrix is a 3×3 matrix A 330, the second matrix is a 3×4 matrix B 332, and the matrix B 332 is split into 2 matrix blocks, such as the first matrix block 334 and the second matrix block 336, with each matrix block comprising 2 columns of elements. That is, the first preset quantity is 2, the second preset quantity is 3, and the third preset quantity is 2. For the first matrix block 334 and for an element in the 1^{st} row (that is, i is equal to 1), k is equal to 1, all elements in the 1^{st} row of the matrix A are multiplied by the element in the 1^{st} row and the 1^{st} column in this matrix block to obtain a reference intermediate result 1 corresponding to the element in the 1^{st} column, and the reference intermediate result 1 is determined as the initial intermediate result 1. Since the current k is equal to 1 and is not equal to the third preset quantity, k is increased by 1, all elements in the P t row of the matrix A are multiplied by the element in the 1^{st} row and the 2^{nd} column in the matrix block to obtain a reference intermediate result 2 corresponding to the element in the 2^{nd} column, and the reference intermediate result 2 is determined as the initial intermediate result 2. Since the current k is equal to the third preset quantity, in this case, the obtained reference intermediate result 1 and the reference intermediate result 2 are determined as the target intermediate results corresponding to the 1^{st} row.

The i is increased by 1, and then i is equal to 2; all elements in the 2nd row of the matrix A are multiplied by the element in the 2^{nd} row and the 1^{st} column in the matrix block to obtain a reference intermediate result 3 corresponding to the element in the 1^{st} column, and the reference intermediate result 3 is added to the initial intermediate result 1 to obtain a target intermediate result 1. Since the current k is equal to 1 and not equal to the third preset quantity, k is increased by 1, all elements in the 2^{nd} row of the matrix A are multiplied by the element in the 2^{nd} row and the 2^{nd} column in the matrix block to obtain a reference intermediate result 4 corresponding to the element in the 2^{nd} column, and the reference intermediate result 4 is added to the initial intermediate result 2 to obtain a target intermediate result 2. Since the current k is equal to the third preset quantity, the obtained target intermediate result 1 and the target intermediate result 2 are determined as the target intermediate results corresponding to the 2^{nd} row.

Since i is equal to 2 and is not equal to the second preset quantity in this case, the determined target intermediate result corresponding to the 2^{nd} row is determined as the initial intermediate result. That is, the target intermediate result corresponding to the 2^{nd} row and the 1^{st} column is determined as the initial intermediate result corresponding to the element in the 1^{st} column, and the target intermediate result corresponding to the 2^{nd} row and the 2^{nd} column is determined as the initial intermediate result corresponding to the element in the 2^{nd} column. In this case, the initial intermediate result 1 is the target intermediate result 1, and the initial intermediate result 2 is the target intermediate result 2. Then, i is increased by 1, all elements in the 3^{rd} row of the matrix A are multiplied with the element in the 3^{rd} row and the 1^{st} column in the matrix block to obtain a reference intermediate result 5 corresponding to the element in the 1^{st} column, and the reference intermediate result 5 is added to the initial intermediate result 1 (the target intermediate result 1) to obtain a target intermediate result 3. Since the current k is equal to 1 and not equal to the third preset quantity, k is increased by 1, all elements in the 3^{rd} row of the matrix A are multiplied by the element in the 3^{rd} row and the 2^{nd} column in the matrix block to obtain a reference intermediate result 6 corresponding to the element in the 2^{nd} column, and the reference intermediate result 6 is added to the initial intermediate result 2 (the target intermediate result 2) to obtain a target intermediate result 4. Since the current k is equal to the third preset quantity, the obtained target intermediate result 3 and the target intermediate result 4 are determined as the target intermediate results corresponding to the 3^{rd} row.

Since i is equal to the second preset quantity in this case, the target intermediate result corresponding to the 3^{rd} row is determined as a matrix block operation result corresponding to the 1^{st} matrix block. That is, the matrix block operation result corresponding to the 1^{st} matrix block in this case is the target intermediate result 3 and the target intermediate result 4. The target intermediate result 3 is used to cover the element in the 1^{st} column of the 1^{st} matrix block, and the target intermediate result 4 is used to cover the element in the 2^{nd} column of the 1^{st} matrix block to obtain the updated 1^{st} matrix block.

The above-described operation is repeated for the second matrix block 336, and a matrix block operation result corresponding to the 2^{nd} matrix block can be obtained, so that a target matrix after the matrix multiplication operation is obtained.

In addition, the operation process described in this embodiment is similar to the operation process described in the embodiment shown in FIG. 2A. Therefore, the above-described embodiment shown in FIG. 2A can be referred to for the details of the implementation of directly performing an operation without presetting an initial intermediate result. The details are not described herein again by the embodiments of the present disclosure.

An embodiment of the present disclosure provides a high-performance matrix modular multiplication algorithm based on Montgomery modular multiplication and addition, wherein a second matrix is split into a plurality of matrix blocks, and then a result of the operation with the first matrix is used to cover an original element in the matrix block to obtain a target matrix after the matrix multiplication operation, which simplifies an operation process of the matrix multiplication operation and reduces operation complexity. In addition, a complex operation between an element included in the first matrix and an element included in a j^{th} matrix block can be implemented by invoking a Montgomery modular multiplication and addition instruction, so as to obtain a target matrix after a final matrix multiplication operation is performed, which effectively uses the advantages of batch processing of the Montgomery modular multiplication and addition instruction, and improves the operation efficiency of a processor performing a matrix multiplication operation, so that the data processing efficiency is improved, and the operation time of performing matrix multiplication operation on a matrix is saved.

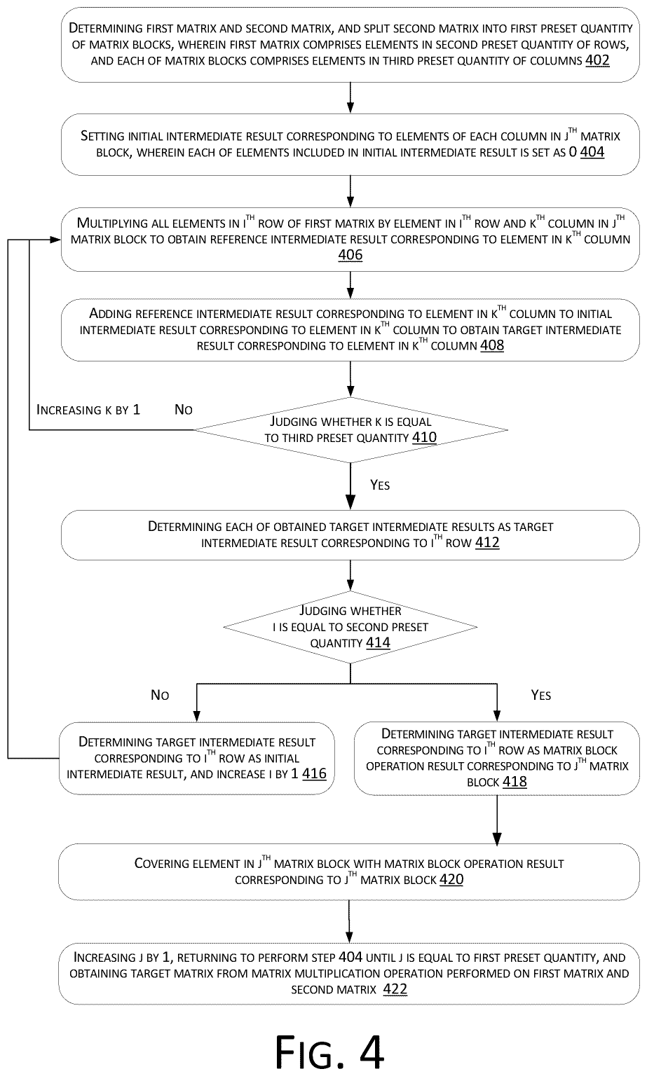

FIG. 4 shows a flowchart of another data processing method according to an embodiment of the present disclosure. As shown in FIG. 4, the method comprises:

Step 402: determining a first matrix and a second matrix, and splitting the second matrix into a first preset quantity of matrix blocks, wherein the first matrix comprises elements in a second preset quantity of rows, and each of the matrix blocks comprises elements in a third preset quantity of columns.

Step 404: setting an initial intermediate result corresponding to elements of each column in the j^{th} matrix block, wherein each of the elements included in the initial intermediate result is set as 0. For example, j starts from 1.

Step 406: multiplying all the elements in the i^{th} row of the first matrix by an element in an i^{th} row and a k^{th} column in the j^{th} matrix block to obtain a reference intermediate result corresponding to the element in the k^{th} column. For example, k starts from 1.

Step 408: adding the reference intermediate result corresponding to the element in the k^{th} column to an initial intermediate result corresponding to the element in the k^{th} column to obtain a target intermediate result corresponding to the element in the k^{th} column.

Step 410: judging whether k is equal to the third preset quantity; if not, increasing k by 1 and continuing to perform the step 406; and if so, performing step 412.

Step 412: determining each of the obtained target intermediate results as the target intermediate result corresponding to the i^{th} row.

Step 414: judging whether i is equal to the second preset quantity; if not, performing step 416; and if so, performing step 418.

Step 416: determining the target intermediate result corresponding to the i^{th} row as the initial intermediate result, increasing i by 1, and continuing to perform the step 406.

Step 418: determining the target intermediate result corresponding to the i^{th} row as the matrix block operation result corresponding to the j^{th} matrix block.

Step 420: covering the element in the j^{th} matrix block with the matrix block operation result corresponding to the j^{th} matrix block.

Step 422: increasing j by 1, returning to perform the step 404 until j is equal to the first preset quantity, and obtaining a target matrix from the matrix multiplication operation performed on the first matrix and the second matrix.

It should be noted that, for a 1^{st} row, an element in the 1^{st} row of the first matrix and the j^{th} matrix block are operated to obtain a target intermediate result corresponding to the 1^{st} row. Since no data is present before the 1^{st} row, there is no need to combine with the previous data, and an element included in an initial intermediate result may be set as 0. Then, the target intermediate result obtained in the 1^{st} row may be combined with the initial intermediate result, and the target intermediate result corresponding to the 1^{st} row may be determined as the initial intermediate result. That is, the initial intermediate result is updated according to the target intermediate result corresponding to the 1^{st} row. By analogy, after the target intermediate result corresponding to each row is obtained, the initial intermediate result is updated until the target intermediate result corresponding to the last row is obtained.

In addition, the operation process described in this embodiment is similar to the operation process described in the embodiment shown in FIG. 2A. Therefore, the above-described embodiment shown in FIG. 2A can be referred to for the details of the implementation of first presetting an initial intermediate result and then performing an operation. The details are not described herein again by the embodiments of the present disclosure.

An embodiment of the present disclosure provides a high-performance matrix modular multiplication algorithm based on Montgomery modular multiplication and addition, wherein a second matrix is split into a plurality of matrix blocks, and then a result of the operation with the first matrix is used to cover an original element in the matrix block to obtain a target matrix after the matrix multiplication operation, which simplifies an operation process of the matrix multiplication operation on a matrix and reduces operation complexity. In addition, a complex operation between an element included in the first matrix and an element included in a j^{th} matrix block can be implemented by invoking a Montgomery modular multiplication and addition instruction, so as to obtain a target matrix after a final matrix multiplication operation is performed, which effectively uses the advantages of batch processing of the Montgomery modular multiplication and addition instruction, and improves the operation efficiency of a processor performing a matrix multiplication operation, so that the data processing efficiency is improved, and the operation time of performing matrix multiplication operation on a matrix is saved.

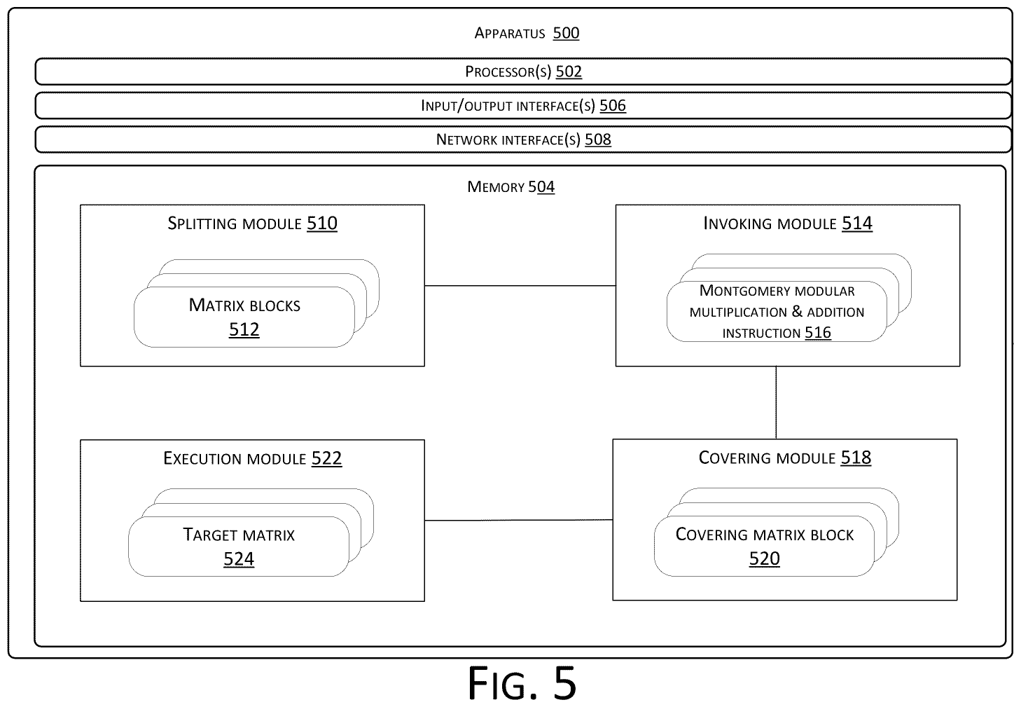

Corresponding to the above-described method embodiment, the present disclosure further provides an embodiment of a data processing apparatus, and FIG. 5 is a schematic diagram of a structure of a data processing apparatus according to an embodiment of the present disclosure.

As shown in FIG. 5, the apparatus 500 includes one or more processor(s) 502 or data processing unit(s) and memory 504. The apparatus 500 may further include one or more input/output interface(s) 506 and one or more network interface(s) 508.

The memory 504 is an example of computer readable media. The computer readable media include non-volatile and volatile media as well as movable and non-movable media, and can implement information storage by means of any method or technology. Information may be a computer readable instruction, a data structure, and a module of a program or other data. An example of the storage media of a computer includes, but is not limited to, a phase-change memory (PRAM), a static random access memory (SRAM), a dynamic random access memory (DRAM), other types of RAMs, a ROM, an electrically erasable programmable read-only memory (EEPROM), a flash memory or other memory technologies, a compact disc read-only memory (CD-ROM), a digital versatile disc (DVD) or other optical storages, a cassette tape, a magnetic tape/magnetic disk storage or other magnetic storage devices, or any other non-transmission media, and can be used to store information accessible by the computing device. According to the definition in this text, the computer readable media does not include transitory computer readable media or transitory media such as a modulated data signal and carrier.

The memory 504 may store therein a plurality of modules or units including:
a splitting module 510, configured to determine a first matrix and a second matrix, and split the second matrix into a first preset quantity of matrix blocks 512;
an invoking module 514, configured to invoke a Montgomery modular multiplication and addition instruction 516 to perform an operation on an element included in the first matrix and an element included in a j^{th} matrix block to obtain a matrix block operation result corresponding to the j^{th} matrix block. For example, j starts from 1. The Montgomery modular multiplication and addition instruction 516 is used to simultaneously implement multiplication and addition operations of a Montgomery domain;
a covering module 518, configured to cover the element in the j^{th} matrix block with the cover matrix block 520 or the matrix block operation result corresponding to the j^{th} matrix block; and
an execution module 522, configured to increase j by 1, continue to execute the invoking module 514 until j is equal to the first preset quantity, and obtain a target matrix 524 from the matrix multiplication operation performed on the first matrix and the second matrix.

For example, the first matrix comprises elements in a second preset quantity of rows; and
correspondingly, the invoking module 514 further comprises:
a setting submodule, configured to set an initial intermediate result corresponding to elements of each column in the j^{th} matrix block, wherein each of the elements included in the initial intermediate result is set as 0;
an operation submodule, configured to perform an operation on all elements in an i^{th} row of the first matrix and the element included in the j^{th} matrix block to obtain a target intermediate result corresponding to the i^{th} row, and, for example, i starts from 1;
a judging submodule, configured to judge whether i is equal to the second preset quantity; if not, run a first determining submodule; and if so, run a second determining submodule;
the first determining submodule, configured to determine the target intermediate result corresponding to the i^{th} row as the initial intermediate result, increase i by 1, and continue to run the operation submodule; and
the second determining submodule, configured to determine the target intermediate result corresponding to the i^{th} row as the matrix block operation result corresponding to the j^{th} matrix block.

For example, each of the matrix blocks comprises elements in a third preset quantity of columns; and
correspondingly, the operation submodule further comprises:
a multiplication subunit, configured to multiply all elements in the i^{th} row of the first matrix by the element in an i^{th} row and a k^{th} column in the j^{th} matrix block to obtain a reference intermediate result corresponding to the element in the k^{th} column, and, for example, k starts from 1;
an addition subunit, configured to add the reference intermediate result corresponding to the element in the k^{th} column to an initial intermediate result corresponding to the element in the k^{th} column to obtain a target intermediate result corresponding to the element in the k^{th} column;
a judging subunit, configured to judge whether k is equal to the third preset quantity; if not, increase k by 1 and continue to run the above-described multiplication subunit; and if so, run the following determining subunit; and
the determining subunit, configured to determine each of the obtained target intermediate results as the target intermediate result corresponding to the i^{th} row.

For example, the apparatus further comprises a setting module configured to:
set the Montgomery modular multiplication and addition instruction, wherein the Montgomery modular multiplication and addition instruction comprises an operation type identifier, a first source operand, a second source operand, a third source operand, and a target operand.

For example, the operation submodule is further configured to:
determine the operation type identifier, the first source operand, the second source operand, and the third source operand according to an operation process of all the elements in the i^{th} row of the first matrix and the element comprised in the j^{th} matrix block;
invoke the Montgomery modular multiplication and addition instruction to run the multiplication subunit and the addition subunit according to the operation type identifier, the first source operand, the second source operand, and the third source operand; and
take the target operand obtained after executing the Montgomery modular multiplication and addition instruction as the target intermediate result.

For example, the operation submodule is further configured to:
determine the operation type identifier as a multiplication and addition operation according to the multiplication subunit and the addition subunit run in the operation process of all elements in the it h row of the first matrix and the element included in the j^{th} matrix block; and
determine the initial intermediate result as the first source operand, determining all the elements in the i^{th} row of the first matrix as the second source operands, and determining the element in the i^{th} row and the k^{th} column in the j^{th} matrix block as the third source operand.

For example, the apparatus further comprises a storage module configured to:
store the j^{th} matrix block into a buffer space; and
correspondingly, the invoking module 514 is further configured to:
read the j^{th} matrix block from the buffer space; and
invoke the Montgomery modular multiplication and addition instruction to perform an operation on the element comprised in the first matrix and an element comprised in the read j^{th} matrix block to obtain the matrix block operation result corresponding to the j^{th} matrix block.

For example, the splitting module 510 is further configured to:
determine a buffer capacity of the buffer space;
determine a quantity of stored columns of the buffer space for the second matrix according to the buffer capacity;
determine the first preset quantity according to a total quantity of columns of the second matrix and the quantity of stored columns; and
split the second matrix into the first preset quantity of matrix blocks, wherein each of the matrix blocks comprises elements in a second preset quantity of columns.

An embodiment of the present disclosure provides a data processing apparatus, wherein a second matrix is split into a plurality of matrix blocks, and then a result of the operation with the first matrix is used to cover an original element in the matrix block to obtain a target matrix after the matrix multiplication operation, which simplifies an operation process of the matrix multiplication operation and reduces operation complexity. In addition, a complex operation between an element included in the first matrix and an element included in a j^{th} matrix block can be implemented by invoking a Montgomery modular multiplication and addition instruction, so as to obtain a target matrix after a final matrix multiplication operation is performed, which effectively uses the advantages of batch processing of the Montgomery modular multiplication and addition instruction, and improves the operation efficiency of a processor performing a matrix multiplication operation, so that the data processing efficiency is improved, and the operation time of performing matrix multiplication operation on a matrix is saved.

The various embodiments in the present disclosure are all described in a progressive manner. Other embodiments may be referred to for the same or similar parts among the various embodiments, and each of the embodiments focuses on the parts differing from the other embodiments. Especially, the data processing apparatus embodiment is basically similar to a method embodiment, and therefore is described briefly; and for related parts, reference may be made to partial descriptions in the method embodiment.

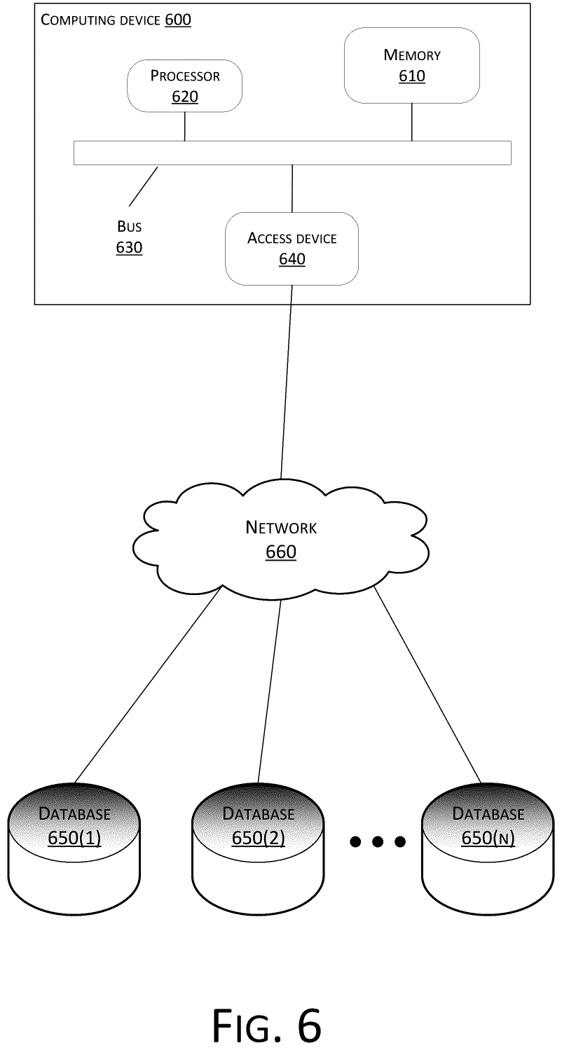

FIG. 6 shows a structural block diagram of a computing device 600 according to an embodiment of the present disclosure. Components of the computing device 600 include, but are not limited to, a memory 610 and a processor 620. The processor 620 is connected to the memory 610 through a bus 630, and one or more databases 650(1) 650(2), . . . , 650(n), where n may be any integer, are used for saving data.

The computing device 600 further includes an access device 640, wherein the access device 640 enables the computing device 600 to communicate via one or more networks 660. Examples of such networks include a public switched telephone network (PSTN), a local area network (LAN), a wide area network (WAN), a personal area network (PAN), or a combination of communication networks such as the Internet. The access device 640 may comprise one or more of any type of network interface (for example, a network interface card (NIC)), such as an IEEE802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and a near field communication (NFC) interface.

In one embodiment of the present disclosure, the above-described components of the computing device 600 and other components not shown in FIG. 6 may also be connected to each other, such as through a bus. It should be understood that the structural block diagram of the computing device shown in FIG. 6 is only for the purpose of example, rather than limiting the scope of the present disclosure. Other components may be added or replaced as desired by those skilled in the art.

The computing device 600 may be any type of stationary or mobile computing device, including a mobile computer or mobile computing device (for example, a tablet computer, a personal digital assistant, a laptop computer, a notebook computer, and a netbook), a mobile phone (for example, a smartphone), a wearable computing device (for example, a smartwatch and a smart glasses), or other type of mobile device, or a stationary computing device such as a desktop computer or PC. The computing device 600 may also be a mobile or stationary server.

The processor 620 is configured to execute the following computer-executable instructions to implement the following steps:
S202: determine a first matrix and a second matrix, and split the second matrix into a first preset quantity of matrix blocks;
S204: invoke a Montgomery modular multiplication and addition instruction to perform an operation on an element comprised in the first matrix and an element comprised in a j^{th} matrix block to obtain a matrix block operation result corresponding to the j^{th} matrix block, and, for example, j starts from 1, and the Montgomery modular multiplication and addition instruction is used to simultaneously implement multiplication and addition operations of a Montgomery domain;
S206: cover the element in the j^{th} matrix block with the matrix block operation result corresponding to the j^{th} matrix block; and
S208: increase j by 1, continue to perform the step S2 until j is equal to the first preset quantity, and obtain a target matrix from the matrix multiplication operation performed on the first matrix and the second matrix.

The various embodiments in the present disclosure are all described in a progressive manner. Other embodiments may be referred to for the same or similar parts among the various embodiments, and each of the embodiments focuses on the parts differing from the other embodiments. Especially, a computing device embodiment is basically similar to a method embodiment, and therefore is described briefly; and for related parts, reference may be made to partial descriptions in the method embodiment.

An embodiment of the present disclosure further provides a computer-readable storage medium having computer instructions stored thereon, wherein when the instructions are executed by a processor, the steps of the data processing method according to any one of the implementations are implemented.

The various embodiments in the present disclosure are all described in a progressive manner. Other embodiments may be referred to for the same or similar parts among the various embodiments, and each of the embodiments focuses on the parts differing from the other embodiments. Especially, a computer-readable storage medium embodiment is basically similar to a method embodiment, and therefore is described briefly; and for related parts, reference may be made to partial descriptions in the method embodiment.

The above describes specific embodiments of the present disclosure. Other embodiments fall within the protection scope of the appended claims. In some cases, the actions or steps stated in the claims may be performed in a sequence different from those in the embodiments, and the desired result may still be achieved. In addition, the processes described in the accompanying drawings do not necessarily require the specific order or sequential order shown to achieve the desired result. In some implementation manners, multitasking and parallel processing are also feasible or may be advantageous.

The computer instructions include computer program codes that may be in source code forms, object code forms, executable files, some intermediate form, or the like. The computer-readable medium may comprise any entity or apparatus, a recording medium, a USB flash drive, a removable hard disk, a magnetic disk, a compact disc, a computer memory, a read-only memory (ROM), a random access memory (RAM), an electrical carrier signal, a telecommunication signal, a software distribution medium, and the like that can carry the computer program code. It should be noted that content included in the computer-readable medium may be appropriately added or deleted based on requirements of legislation and patent practice in a jurisdiction. For example, in some jurisdictions, according to legislation and patent practice, the computer-readable medium does not include the electrical carrier signal or the telecommunication signal.

It should be noted that with regard to the above-described method embodiments, in order to provide a simple and concise description, the method embodiments are all expressed as a series of action combinations. Those skilled in the art, however, should know that the embodiments of the present disclosure are not limited by the described sequence of actions as some steps may be executed in another sequence or simultaneously according to the embodiments of the present disclosure. Secondly, those skilled in the art should also know that the embodiments described in the present disclosure are all example embodiments, and the involved actions and modules are not necessarily required by the embodiments of the present disclosure.

In the above embodiments, the description of each embodiment has its own emphasis. For any part that is not described in detail in one embodiment, reference may be made to related descriptions in other embodiments.

The example embodiments of the present disclosure disclosed above are provided only to aid in the description of the present disclosure. Alternative embodiments are not intended to exhaust all details, nor do they limit the present invention to only the detailed embodiments described. Apparently, many modifications and changes can be made in accordance with the contents of the embodiments of the present disclosure. These embodiments are selected and described in the present disclosure to better explain the principles and practical applications of the embodiments of the present disclosure, so that those skilled in the art can well understand and utilize the present disclosure. The present disclosure is limited only by the claims and their full scope and equivalents.

The present disclosure may further be understood with clauses as follows:

Clause 1. A data processing method, comprising:
S1: determining a first matrix and a second matrix, and splitting the second matrix into a first preset quantity of matrix blocks;
S2: invoking a Montgomery modular multiplication and addition instruction to perform an operation on an element comprised in the first matrix and an element comprised in a j^{th} matrix block to obtain a matrix block operation result corresponding to the j^{th} matrix block, wherein j starts from 1, and the Montgomery modular multiplication and addition instruction is used to simultaneously implement multiplication and addition operations of a Montgomery domain;
S3: covering the element in the j^{th} matrix block with the matrix block operation result corresponding to the j^{th} matrix block; and
S4: increasing j by 1, continuing to perform the step S2 until j is equal to the first preset quantity, and obtaining a target matrix from the matrix multiplication operation performed on the first matrix and the second matrix.

Clause 2. The data processing method according to clause 1, wherein the first matrix comprises elements in a second preset quantity of rows; and
correspondingly, the invoking a Montgomery modular multiplication and addition instruction to perform an operation on an element comprised in the first matrix and an element comprised in a j^{th} matrix block to obtain a matrix block operation result corresponding to the j^{th} matrix block comprises:
S2041: setting an initial intermediate result corresponding to elements of each column in the j^{th} matrix block, wherein each of the elements comprised in the initial intermediate result is set as 0;
S2042: performing an operation on all elements in an i^{th} row of the first matrix and the element comprised in the j^{th} matrix block to obtain a target intermediate result corresponding to the i^{th} row, wherein i starts from 1;
S2043: judging whether i is equal to the second preset quantity; if not, performing step S2044; and if so, performing step S2045;
S2044: determining the target intermediate result corresponding to the i^{th} row as the initial intermediate result, increasing i by 1, and continuing to perform the step S2042; and S2045: determining the target intermediate result corresponding to the i^{th} row as the matrix block operation result corresponding to the j^{th} matrix block.

Clause 3. The data processing method according to clause 2, wherein each of the matrix blocks comprises elements in a third preset quantity of columns; and
correspondingly, the performing an operation on all elements in an i^{th} row of the first matrix and the element comprised in the j^{th} matrix block to obtain a target intermediate result corresponding to the i^{th} row comprises:
S2041A: multiplying all the elements in the i^{th} row of the first matrix by an element in an i^{th} row and a k^{th} column in the j^{th} matrix block to obtain a reference intermediate result corresponding to the element in the k^{th} column, wherein k starts from 1;
S2042A: adding the reference intermediate result corresponding to the element in the k^{th} column to an initial intermediate result corresponding to the element in the k^{th} column to obtain a target intermediate result corresponding to the element in the k^{th} column;
S2043A: judging whether k is equal to the third preset quantity; if not, increasing k by 1 and continuing to perform the step S2041A; and if so, performing step S2044A; and
S2044A: determining each of the obtained target intermediate results as the target intermediate result corresponding to the i^{th} row.

Clause 4. The data processing method according to clause 3, wherein before the invoking a Montgomery modular multiplication and addition instruction to perform an operation on an element comprised in the first matrix and an element comprised in a j^{th} matrix block to obtain a matrix block operation result corresponding to the j^{th} matrix block, the method further comprises:
setting the Montgomery modular multiplication and addition instruction, wherein the Montgomery modular multiplication and addition instruction comprises an operation type identifier, a first source operand, a second source operand, a third source operand, and a target operand.

Clause 5. The data processing method according to clause 4, wherein the performing an operation on all elements in an i^{th} row of the first matrix and the element comprised in the j^{th} matrix block to obtain a target intermediate result corresponding to the i^{th} row comprises:
determining the operation type identifier, the first source operand, the second source operand, and the third source operand according to an operation process of all the elements in the i^{th} row of the first matrix and the element comprised in the j^{th} matrix block;
invoking the Montgomery modular multiplication and addition instruction to perform the steps S2041A and S2042A according to the operation type identifier, the first source operand, the second source operand, and the third source operand; and
taking the target operand obtained after executing the Montgomery modular multiplication and addition instruction as the target intermediate result.

Clause 6. The data processing method according to clause 5, wherein the determining the operation type identifier, the first source operand, the second source operand, and the third source operand according to an operation process of all the elements in the i^{th} row of the first matrix and the element comprised in the j^{th} matrix block comprises:
determining the operation type identifier as a multiplication and addition operation according to the steps S2041A and S2042A comprised in the operation process of all the elements in the i^{th} row of the first matrix and the element comprised in the j^{th} matrix block; and
determining the initial intermediate result as the first source operand, determining all the elements in the i^{th} row of the first matrix as the second source operands, and determining the element in the i^{th} row and the k^{th} column in the j^{th} matrix block as the third source operand.

Clause 7. The data processing method according to any one of clauses 1 to 6, wherein before the invoking a Montgomery modular multiplication and addition instruction to perform an operation on an element comprised in the first matrix and an element comprised in a j^{th} matrix block to obtain a matrix block operation result corresponding to the j^{th} matrix block, the method further comprises:
storing the j^{th} matrix block into a buffer space; and
correspondingly, the invoking a Montgomery modular multiplication and addition instruction to perform an operation on an element comprised in the first matrix and an element comprised in a j^{th} matrix block to obtain a matrix block operation result corresponding to the j^{th} matrix block comprises:
reading the j^{th} matrix block from the buffer space; and
invoking the Montgomery modular multiplication and addition instruction to perform an operation on the element comprised in the first matrix and an element comprised in the read j^{th} matrix block to obtain the matrix block operation result corresponding to the j^{th} matrix block.

Clause 8. The data processing method according to clause 7, wherein the splitting the second matrix into a first preset quantity of matrix blocks comprises:
determining a buffer capacity of the buffer space;
determining a quantity of stored columns of the buffer space for the second matrix according to the buffer capacity;
determining the first preset quantity according to a total quantity of columns of the second matrix and the quantity of stored columns; and
splitting the second matrix into the first preset quantity of matrix blocks, wherein each of the matrix blocks comprises elements in a second preset quantity of columns.

Clause 9. A data processing apparatus, comprising:
a splitting module, configured to determine a first matrix and a second matrix, and split the second matrix into a first preset quantity of matrix blocks;
an invoking module, configured to invoke a Montgomery modular multiplication and addition instruction to perform an operation on an element comprised in the first matrix and an element comprised in a j^{th} matrix block to obtain a matrix block operation result corresponding to the j^{th} matrix block, wherein j starts from 1, and the Montgomery modular multiplication and addition instruction is used to simultaneously implement multiplication and addition operations of a Montgomery domain;
a covering module, configured to cover the element in the j^{th} matrix block with the matrix block operation result corresponding to the j^{th} matrix block; and
an execution module, configured to increase j by 1, continue to execute the invoking module until j is equal to the first preset quantity, and obtain a target matrix from the matrix multiplication operation performed on the first matrix and the second matrix.

Clause 10. A computing device, comprising:
a memory and a processor;
wherein the memory is configured to store computer-executable instructions, and the processor is configured to execute the computer-executable instructions to implement the following steps:
S1: determine a first matrix and a second matrix, and split the second matrix into a first preset quantity of matrix blocks;
S2: invoke a Montgomery modular multiplication and addition instruction to perform an operation on an element comprised in the first matrix and an element comprised in a j^{th} matrix block to obtain a matrix block operation result corresponding to the j^{th} matrix block, wherein j starts from 1, and the Montgomery modular multiplication and addition instruction is used to simultaneously implement multiplication and addition operations of a Montgomery domain;
S3: cover the element in the j^{th} matrix block with the matrix block operation result corresponding to the j^{th} matrix block; and
S4: increase j by 1, continue to perform the step S2 until j is equal to the first preset quantity, and obtain a target matrix from the matrix multiplication operation performed on the first matrix and the second matrix.

Clause 11. A computer-readable storage medium having computer-executable instructions stored thereon, wherein when the computer-executable instructions are executed by a processor, the steps of the data processing method according to any one of clauses 1 to 9 are implemented.

What is claimed is:

1. A method comprising:
determining a first matrix and a second matrix;
splitting the second matrix into a first preset quantity of matrix blocks;
invoking a Montgomery modular multiplication and addition instruction to perform an operation on one or more elements included in the first matrix and one or more element in a matrix block to obtain a matrix block operation result corresponding to the matrix block, wherein the Montgomery modular multiplication and addition instruction is used to simultaneously implement multiplication and addition operations of a Montgomery domain;
covering the one or more element in the matrix block with the matrix block operation result corresponding to the matrix block;
reiteratively continuing to perform the invoking on one or more element in a next matrix block until all of the first preset quantity of matrix blocks are performed; and
obtaining a target matrix from a matrix multiplication operation performed on the first matrix and the second matrix.

2. The method of claim 1, wherein:
the first matrix comprises one or more elements in a second preset quantity of rows; and
the invoking the Montgomery modular multiplication and addition instruction to perform the operation on the one or more elements included in the first matrix and the one or more element in the matrix block includes:
setting an initial intermediate result corresponding to elements of each column in the matrix block;
performing an operation on one or more elements included in a row of the first matrix and the one or more element included in the matrix block to obtain a target intermediate result corresponding to the row;
determining whether a number of performed rows is equal to the second preset quantity;
in response to determining that the number of performed rows is not equal to the second preset quantity, determining the target intermediate result corresponding to the row as the initial intermediate result, reiteratively continuing to perform the operation on one or more elements in a next row of the first matrix until all of the second preset quantity of rows are performed; and
in response to determining that the number of performed rows is equal to the second preset quantity, determining the target intermediate result as the matrix block operation result corresponding to the matrix block.

3. The method of claim 2, wherein:
each of the matrix blocks comprises elements in a third preset quantity of columns; and
the performing the operation on the one or more elements included in the row of the first matrix and the one or more element included in the matrix block to obtain the target intermediate result corresponding to the row includes:
multiplying all the elements in the row of the first matrix by an element in a row whose row number is the same as the row of the first matrix and a column in the matrix block to obtain a reference intermediate result corresponding to the element in the column;
adding the reference intermediate result corresponding to the element in the column to an initial intermediate result corresponding to the element in the column to obtain a target intermediate result corresponding to the element in the column;
determining whether a number of performed columns is equal to the third preset quantity;
in response to determining that the number of performed columns is not equal to the third preset quantity, reiteratively continuing multiplying all the elements in the row of the first matrix by an element in the row whose row number is the same as the row of the first matrix and a next column in the matrix block until all of the third preset quantity of columns are performed; and
in response to determining that the number of performed columns is equal to the third preset quantity, determining target intermediate results corresponding to columns as the target intermediate result corresponding to the row.

4. The method of claim 1, wherein the invoking includes:
invoking the Montgomery modular multiplication and addition instruction to perform the operation on the one or more elements included in the first matrix and the one or more element included in a j^{th} matrix block to obtain the matrix block operation result corresponding to the j^{th} matrix block, wherein j starts from 1; and
the reiteratively continuing to perform the invoking on one or more element in a next matrix block until all of the first preset quantity of matrix blocks are performed includes:
increasing j by 1; and
continuing to perform the invoking the Montgomery modular multiplication and addition instruction to perform the operation on the one or more elements included in the first matrix and the one or more element included in the j^{th} matrix block until j is equal to the first preset quantity.

5. The method of claim 4, wherein:
the first matrix comprises elements in a second preset quantity of rows; and
the invoking the Montgomery modular multiplication and addition instruction to perform the operation on the one or more elements includes in the first matrix and the one or more elements included in the j^{th} matrix block to obtain the matrix block operation result corresponding to the j^{th} matrix block includes:
setting an initial intermediate result corresponding to one or more elements of each column in the matrix block, wherein each of the elements included in the initial intermediate result is set as 0;
performing an operation on all elements in an i^{th} row of the first matrix and the one or more element comprised in the j^{th} matrix block to obtain a target intermediate result corresponding to the i^{th} row, wherein i starts from 1;
determining whether i is equal to the second preset quantity;
in response to determining that i is not equal to 1,
determining the target intermediate result corresponding to the i^{th} row as the initial intermediate result;
increasing i by 1; and
continuing performing the operation on all elements in the i^{th} row of the first matrix and the one or more element comprised in the j^{th} matrix block;
in response to determining that i is equal to 1, determining the target intermediate result corresponding to the i^{th} row as the matrix block operation result corresponding to the j^{th} matrix block.

6. The method of claim 5, wherein:
each of the matrix blocks comprises elements in a third preset quantity of columns; and
the performing the operation on all elements in the i^{th} row of the first matrix and the element comprised in the j^{th} matrix block to obtain the target intermediate result corresponding to the i^{th} row comprises:
multiplying all the elements in the i^{th} row of the first matrix by an element in an i^{th} row and a k^{th} column in the j^{th} matrix block to obtain a reference intermediate result corresponding to the element in the k^{th} column, wherein k starts from 1;
adding the reference intermediate result corresponding to the element in the k^{th} column to an initial intermediate result corresponding to the element in the k^{th} column to obtain a target intermediate result corresponding to the element in the k^{th} column;
determining whether k is equal to the third preset quantity;
in response to determining that k is not equal to 1,
increasing i by 1; and
continuing to multiplying all the elements in the ith row of the first matrix by the element in the ith row and the kth column in the j^{th} matrix block;
in response to determining that k is equal to 1, determining each of the obtained target intermediate results as the target intermediate result corresponding to the i^{th} row.

7. The method of claim 6, wherein prior to the invoking the Montgomery modular multiplication and addition instruction to perform the operation on the one or more elements included in the first matrix and the one or more element included in the j^{th} matrix block to obtain the matrix block operation result corresponding to the j^{th} matrix block, the method further comprises:
setting the Montgomery modular multiplication and addition instruction, wherein the Montgomery modular multiplication and addition instruction comprises an operation type identifier, a first source operand, a second source operand, a third source operand, and a target operand.

8. The method of claim 7, wherein the performing the operation on all elements in the i^{th} row of the first matrix and the element comprised in the j^{th} matrix block to obtain the target intermediate result corresponding to the i^{th} row comprises:
determining the operation type identifier, the first source operand, the second source operand, and the third source operand according to an operation process of all the elements in the i^{th} row of the first matrix and the element in the j^{th} matrix block;
according to the operation type identifier, the first source operand, the second source operand, and the third source operand, invoking the Montgomery modular multiplication and addition instruction to perform specific steps including:
multiplying all the elements in the i^{th} row of the first matrix by the element in the i^{th} row and a k^{th} column in the j^{th} matrix block to obtain the reference intermediate result corresponding to the element in the k^{th} column, wherein k starts from 1;
adding the reference intermediate result corresponding to the element in the k^{th} column to the initial intermediate result corresponding to the element in the k^{th} column to obtain the target intermediate result corresponding to the element in the k^{th} column; and
using the target operand obtained after executing the Montgomery modular multiplication and addition instruction as the target intermediate result.

9. The method of claim 8, wherein the determining the operation type identifier, the first source operand, the second source operand, and the third source operand according to the operation process of all the elements in the i^{th} row of the first matrix and the element comprised in the j^{th} matrix block includes:
determining the operation type identifier as a multiplication and addition operation according to the specific steps comprised in the operation process of all the elements in the i^{th} row of the first matrix and the element comprised in the j^{th} matrix block;
determining the initial intermediate result as the first source operand;
determining all of the elements in the i^{th} row of the first matrix as the second source operands; and
determining the element in the i^{th} row and the k^{th} column in the j^{th} matrix block as the third source operand.

10. The method of claim 1, wherein:
prior to the invoking the Montgomery modular multiplication and addition instruction to perform the operation on the one or more element included in the first matrix and the one or more elements included in the matrix block to obtain the matrix block operation result corresponding to the matrix block, the method further comprises storing the matrix block into a buffer space; and
the invoking the Montgomery modular multiplication and addition instruction to perform the operation on the one or more element included in the first matrix and the one or more elements included in the matrix block to obtain the matrix block operation result corresponding to the matrix block includes:
reading the matrix block from the buffer space; and
invoking the Montgomery modular multiplication and addition instruction to perform the operation on the one or more element included in the first matrix and the one or more element included in the read matrix block to obtain the matrix block operation result corresponding to the matrix block.

11. The method of claim 10, wherein:
the splitting the second matrix into a first preset quantity of matrix blocks comprises:
determining a buffer capacity of the buffer space;
determining a quantity of stored columns of the buffer space for the second matrix according to the buffer capacity;
determining the first preset quantity according to a total quantity of columns of the second matrix and the quantity of stored columns; and
splitting the second matrix into the first preset quantity of matrix blocks, wherein each of the matrix blocks comprises elements in a second preset quantity of columns.

12. An apparatus comprising:
one or more processors; and
one or more memories storing thereon computer-readable instructions that, when executed by the one or more processors, cause the one or more processors to perform acts comprising:
determining a first matrix and a second matrix;
splitting the second matrix into a first preset quantity of matrix blocks;
invoking a Montgomery modular multiplication and addition instruction to perform an operation on one or more elements included in the first matrix and one or more element in a j^{th} matrix block to obtain a matrix block operation result corresponding to the j^{th} matrix block, wherein j starts from 1 and the Montgomery modular multiplication and addition instruction is used to simultaneously implement multiplication and addition operations of a Montgomery domain;
covering the one or more element in the matrix block with the matrix block operation result corresponding to the matrix block;
increasing j by 1;
continuing to perform the invoking the Montgomery modular multiplication and addition instruction to perform the operation on the one or more elements included in the first matrix and the one or more element included in the j^{th} matrix block until j is equal to the first preset quantity; and
obtaining a target matrix from a matrix multiplication operation performed on the first matrix and the second matrix.

13. The apparatus of claim 12, wherein:
the first matrix comprises elements in a second preset quantity of rows; and
the invoking the Montgomery modular multiplication and addition instruction to perform the operation on the one or more elements includes in the first matrix and the one or more elements included in the j^{th} matrix block to obtain the matrix block operation result corresponding to the j^{th} matrix block includes:
setting an initial intermediate result corresponding to one or more elements of each column in the matrix block, wherein each of the elements included in the initial intermediate result is set as 0;
performing an operation on all elements in an i^{th} row of the first matrix and the one or more element comprised in the j^{th} matrix block to obtain a target intermediate result corresponding to the i^{th} row, wherein i starts from 1;
determining whether i is equal to the second preset quantity;
in response to determining that i is not equal to 1,
determining the target intermediate result corresponding to the i^{th} row as the initial intermediate result;
increasing i by 1; and
continuing performing the operation on all elements in the ith row of the first matrix and the one or more element comprised in the jth matrix block;
in response to determining that i is equal to 1, determining the target intermediate result corresponding to the i^{th} row as the matrix block operation result corresponding to the j^{th} matrix block.

14. The apparatus of claim 13, wherein:
each of the matrix blocks comprises elements in a third preset quantity of columns; and
the performing the operation on all elements in the i^{th} row of the first matrix and the element comprised in the j^{th} matrix block to obtain the target intermediate result corresponding to the i^{th} row comprises:
multiplying all the elements in the i^{th} row of the first matrix by an element in an i^{th} row and a k^{th} column in the j^{th} matrix block to obtain a reference intermediate result corresponding to the element in the k^{th} column, wherein k starts from 1;
adding the reference intermediate result corresponding to the element in the k^{th} column to an initial intermediate result corresponding to the element in the k^{th} column to obtain a target intermediate result corresponding to the element in the k^{th} column;
determining whether k is equal to the third preset quantity;
in response to determining that k is not equal to 1,
increasing i by 1; and
continuing to multiplying all the elements in the ith row of the first matrix by the element in the ith row and the kth column in the jth matrix block;
in response to determining that k is equal to 1, determining each of the obtained target intermediate results as the target intermediate result corresponding to the i^{th} row.

15. The apparatus of claim 14, wherein prior to the invoking the Montgomery modular multiplication and addition instruction to perform the operation on the one or more elements included in the first matrix and the one or more element included in the j^{th} matrix block to obtain the matrix block operation result corresponding to the j^{th} matrix block, the acts further comprise:
setting the Montgomery modular multiplication and addition instruction, wherein the Montgomery modular multiplication and addition instruction comprises an operation type identifier, a first source operand, a second source operand, a third source operand, and a target operand.

16. The apparatus of claim 15, wherein the performing the operation on all elements in the i^{th} row of the first matrix and the element comprised in the j^{th} matrix block to obtain the target intermediate result corresponding to the i^{th} row comprises:
determining the operation type identifier, the first source operand, the second source operand, and the third source operand according to an operation process of all the elements in the i^{th} row of the first matrix and the element in the j^{th} matrix block;
according to the operation type identifier, the first source operand, the second source operand, and the third source operand, invoking the Montgomery modular multiplication and addition instruction to perform specific steps including:
multiplying all the elements in the i^{th} row of the first matrix by the element in the i^{th} row and a k^{th} column in the j^{th} matrix block to obtain the reference intermediate result corresponding to the element in the k^{th} column, wherein k starts from 1;
adding the reference intermediate result corresponding to the element in the k^{th} column to the initial intermediate result corresponding to the element in the k^{th} column to obtain the target intermediate result corresponding to the element in the k^{th} column; and
using the target operand obtained after executing the Montgomery modular multiplication and addition instruction as the target intermediate result.

17. The apparatus of claim 16, wherein the determining the operation type identifier, the first source operand, the second source operand, and the third source operand according to the operation process of all the elements in the i^{th} row of the first matrix and the element comprised in the j^{th} matrix block includes:
determining the operation type identifier as a multiplication and addition operation according to the specific steps comprised in the operation process of all the elements in the i^{th} row of the first matrix and the element comprised in the j^{th} matrix block;
determining the initial intermediate result as the first source operand;
determining all of the elements in the i^{th} row of the first matrix as the second source operands; and
determining the element in the i^{th} row and the k^{th} column in the j^{th} matrix block as the third source operand.

18. One or more memories storing thereon computer-readable instructions that, when executed by one or more processors, cause the one or more processors to perform acts comprising:
determining a first matrix and a second matrix;
splitting the second matrix into a first preset quantity of matrix blocks;
invoking a Montgomery modular multiplication and addition instruction to perform an operation on one or more elements included in the first matrix and one or more element in a matrix block to obtain a matrix block operation result corresponding to the matrix block, wherein the Montgomery modular multiplication and addition instruction is used to simultaneously implement multiplication and addition operations of a Montgomery domain;
covering the one or more element in the matrix block with the matrix block operation result corresponding to the matrix block;
reiteratively continuing to perform the invoking on one or more element in a next matrix block until all of the first preset quantity of matrix blocks are performed; and
obtaining a target matrix from a matrix multiplication operation performed on the first matrix and the second matrix.

19. The one or more memories of claim 18, wherein:
prior to the invoking the Montgomery modular multiplication and addition instruction to perform the operation on the one or more element included in the first matrix and the one or more elements included in the matrix block to obtain the matrix block operation result corresponding to the matrix block, the acts further comprise storing the matrix block into a buffer space; and
the invoking the Montgomery modular multiplication and addition instruction to perform the operation on the one or more element included in the first matrix and the one or more elements included in the matrix block to obtain the matrix block operation result corresponding to the matrix block includes:
reading the matrix block from the buffer space; and
invoking the Montgomery modular multiplication and addition instruction to perform the operation on the one or more element included in the first matrix and the one or more element included in the read matrix block to obtain the matrix block operation result corresponding to the matrix block.

20. The one or more memories of claim 19, wherein:
the splitting the second matrix into a first preset quantity of matrix blocks comprises:
determining a buffer capacity of the buffer space;
determining a quantity of stored columns of the buffer space for the second matrix according to the buffer capacity;
determining the first preset quantity according to a total quantity of columns of the second matrix and the quantity of stored columns; and
splitting the second matrix into the first preset quantity of matrix blocks, wherein each of the matrix blocks comprises elements in a second preset quantity of columns.
